(19) United States
(12) Patent Application Publication
(10) Pub. No.: US 2021/0033106 A1
(43) Pub. Date: Feb. 4, 2021

(54) DELIVERY DEVICE COMPRISING A SIDE CHANNEL BLOWER OR PERIPHERAL BLOWER

(71) Applicant: Schwäbische Hüttenwerke Automotive GmbH, Aalen-Wasseralfingen (DE)

(72) Inventors: Dominik Baur, Scheer (DE); Uwe Meinig, Bad Saulgau (DE)

(21) Appl. No.: 16/940,818

(22) Filed: Jul. 28, 2020

(30) Foreign Application Priority Data
Jul. 29, 2019 (DE) 102019120410.0

(51) Int. Cl. F04D 29/44; F04D 23/00; F04D 29/28; F04D 29/30; F04D 29/42; F04D 29/66

(52) U.S. Cl. CPC F04D 29/441; F04D 23/008; F04D 29/663; F04D 29/30; F04D 29/4206; F04D 29/281

(57) ABSTRACT

A delivery device for a medium to be delivered, for example for purging a filter for volatile fuel components, including a blower, which is embodied as a side channel blower or peripheral blower, and optionally an electric drive motor for the blower. The blower including: a housing, including: an inlet and an outlet for the medium to be delivered, for example purge air; a delivery channel which extends in the circumferential direction and has a side channel; and an interrupter channel which extends in the circumferential direction for separating the inlet and the outlet; and an impeller which can rotate in the housing about a rotational axis and includes paddles which, when the impeller is rotated, pass through the delivery channel and the interrupter channel. The delivery device is configured such that the delivery-pressure-over-delivery-flow characteristic curve of the delivery device or the blower flattens or drops towards minimum delivery flow.

### CROSS REFERENCE TO RELATED APPLICATION

This application claims benefit of priority to German Patent Application No. 10 2019 120 410.0, filed Jul. 29, 2019. The contents of this application are incorporated herein by reference.

### FIELD OF THE INVENTION

The invention relates to a delivery device comprising a blower, which is embodied as a side channel blower or peripheral blower, for delivering a medium to be delivered. One preferred area of application is in motor vehicle manufacturing. The delivery device can for example be used as a secondary air pump for an exhaust gas system of a combustion engine and in particular for purging a filter or other storage medium for volatile fuel components.

### BACKGROUND OF THE INVENTION

In fuel supply systems of spark-ignition engines, vaporised fuel components are collected by means of filters and supplied to the combustion engine via the latter's suction region. Typically used filters include activated carbon filters (ACFs) which store volatile fuel components and thus clean the gases which escape when a tank is vented. In order for the filter effect to be maintained, the filter has to be purged and thus regenerated from time to time. This is achieved by reverse-flow purging. The purge gas is supplied to the combustion process of the combustion engine. Due to rising demands on environmental compatibility, the operating times during which reverse-flow purging of the filter loaded with volatile fuel components is expedient are becoming ever shorter. The combustion engine which serves as the drive motor of a vehicle is for example switched off when the vehicle is at a stop. It thus becomes all the more important that the operating states of the combustion engine which are suitable for supplying the volatile fuel components into the combustion process be used intensively for regenerating the filter, but disrupt fuel-mixing by the combustion engine as little as possible.

Radial blowers are currently used sporadically in purge gas systems to deliver the volatile fuel components, contained in the filter purge gas flow, into the suction region of the combustion engine. Radial blowers operate at very high working rotational speeds of up to 60,000 rpm, in order to achieve the pressures required for purging the filter. The high working rotational speed makes huge demands on an electric drive of the blower, the balancing quality of the impeller and the tolerances of the component parts. One disadvantage is the unfavourable acoustic properties of radial blowers, in particular their structure-borne noise problems due to imbalance which can only be controlled at great effort and/or expense. The structure-borne noise induced by imbalance increases by the second power of the rotational speed and is huge at the rotational speeds of 50,000 to 60,000 rpm which are required for radial blowers. The design effort and/or expense which has to be invested in acoustic decoupling when attaching the radial blower to a vehicle body is correspondingly large.

Side channel blowers and peripheral blowers are significantly more favourable in terms of their required working rotational speed for use in motor vehicles. They get by on rotational speeds of 20,000 rpm, so around a third of the rotational speed level required for radial blowers, in order to generate sufficiently high pressures for purging the filters. This substantially defuses the structure-borne noise problems due to imbalance. A purge gas pump based on the side channel principle can be attached in a relatively simple way at the point of installation in the vehicle, for example on the bodywork. Acoustic abnormalities in the interior space of the vehicle can be avoided using relatively simple acoustic decoupling measures.

One advantage and also disadvantage is the very steep “delivery pressure over delivery flow” delivery characteristic curve which is typical of side channel blowers and peripheral blowers. On the one hand, this enables high delivery pressures even at low working rotational speeds. In the overload range, however, i.e. to the left of the nominal point in the diagram of the delivery characteristic curve, the delivery pressure and power consumption of the blower rise to undesirably high values as throttling on the pressure side increases and by association the delivery flow decreases. This can also lead to an undesirably high build-up of pressure in the tank venting system. The dissipation in the blower which rises as the power consumption increases also causes the temperature of the purge gas to rise to an undesirably significant degree, which can become problematic given the highly inflammable fuel components (hydrocarbon mixtures) to be delivered.

The use of side channel blowers and peripheral blowers in purge gas systems is known in principle, for example from DE 197 09 903 A1 and DE 197 40 582 A1, each of which are incorporated by reference herein.

DE 10 2011 108 763 B4, incorporated by reference herein, discloses the use of a side channel blower as a secondary air pump for an exhaust gas system and proposes embodying the side channel blower as a dual-flux blower in order to reduce the power consumption. The reduced circumferential extent of the respective delivery channel which is associated with the dual-flux design establishes a delivery-pressure-over-delivery-flow characteristic curve which is flatter but still rises linearly up to zero delivery.

U.S. Pat. No. 3,280,752 B incorporated by reference herein, discloses a side channel pump comprising a side channel into which fins, acting as flow channelling elements, protrude. A flattening of the delivery-pressure-over-delivery-flow characteristic curve towards zero delivery is described for this blower. DE 21 21 280 A, incorporated by reference herein, proposes arranging one or more grooves in the side channel in order to achieve a similar effect.

US 2007/0160456 A1 incorporated by reference herein, takes a different tack. In a first example embodiment, side channel blowers known from this document comprise a rotor wheel comprising paddles which comprise local constrictions on their axial end-facing sides. A peripheral blower of a second example embodiment comprises a groove in the interrupter channel which separates the inlet from the outlet of the blower. In both example embodiments, a leakage via the interrupter channel and thus a flattening of the delivery-pressure-over-delivery-flow characteristic curve towards zero delivery is specifically established.

The known measures for achieving a flattened delivery-pressure-over-delivery-flow characteristic curve towards zero delivery are associated with a considerable design effort and/or expense. This applies in particular to arranging flow channelling fins, and to a lesser extent also in principle grooves, in the side channel or interrupter channel. Grooves in the interrupter channel, as also the constrictions on the end-facing sides of the paddles, have the additional disadvantage that a concentrated, high-energy fluid jet in the inlet region of the delivery channel forms at the groove exit or in the region of the constriction on the paddles, and this tangential fluid jet penetrates far into the delivery channel. The concentrated fluid jet disrupts the flow in the inlet region and delays the fanning of the rotational component of the fluid flow, required for energy transmission, in the delivery channel. It should be noted in this regard that energy transmission from the impeller to the fluid in the delivery channel only begins at a circumferential angular range of 60° to 80° downstream of the inlet and is shifted even further into the delivery channel by the fluid jet which escapes into the delivery channel from the interrupter channel.

### SUMMARY OF THE INVENTION

An aspect of the invention is a delivery device comprising a blower for delivering a medium to be delivered, wherein the delivery device is suitable for operations varying between a minimum delivery requirement, in most cases a zero requirement, and a temporarily high delivery requirement.

A different or additional aspect is that of providing a delivery device which is suitable with regard to its production of structure-borne noise for use in motor vehicles, for example as a secondary air delivery device or in particular a purge gas delivery device.

Another different or additional object is that of providing a delivery device in which the delivery-pressure-over-delivery-flow characteristic curve is flattened and by association the power consumption is reduced using means which are simple in design.

An aspect of the invention accordingly relates to a delivery device for a medium to be delivered, in order for example to deliver secondary air for an exhaust gas system or in particular to purge a filter for volatile fuel components in the fuel supply system of a motor vehicle. The delivery device comprises a blower, which is embodied as a side channel blower or peripheral blower, for delivering the medium to be delivered. The blower comprises a housing and an impeller which can rotate in the housing about a rotational axis. The housing comprises an inlet and an outlet for the medium to be delivered, a delivery channel which extends in the circumferential direction and comprises a side channel, and an interrupter channel which extends in the circumferential direction for separating the inlet and the outlet. The inlet and the outlet emerge into the delivery channel. The impeller comprises paddles which, when the impeller is rotated, periodically pass through the delivery channel and the interrupter channel in order to deliver the medium to be delivered, which flows through the inlet into the delivery channel, by impulse transmission in the delivery channel, as is known in principle from side channel blowers and peripheral blowers, and expel it through the outlet at an increased pressure.

In accordance with an aspect of than invention, the delivery device is configured such that the delivery-pressure-over-delivery-flow characteristic curve of the blower flattens or as applicable even drops towards minimum delivery flow, i.e. a theoretical zero delivery, such as would occur if the outlet were completely closed.

At a constant rotational speed of the impeller, the delivery-pressure-over-delivery-flow characteristic curve is ascertained by varying a throttling of the blower on the pressure side. To this end, a flow resistance which is expediently a valve downstream of the delivery channel, expediently at or near the outlet of the blower, is altered from a minimum resistance up to a maximum resistance which can in particular correspond to a complete closure. The characteristic curve can be sub-divided into three ranges: an overload range, a nominal range and a full-load range. The nominal range extends around the nominal working point, or “nominal point” for short, of the blower. If, proceeding from the nominal range, the throttling on the pressure side is reduced, the blower operates in its full-load range. If, proceeding from the nominal range, the throttling on the pressure side is increased, the blower operates in its overload range. If, in a diagram of the characteristic curve, the delivery flow is plotted along the X-axis and the difference in delivery pressure between the blower outlet and the blower inlet is plotted along the Y-axis, the overload range extends from the left up to the nominal range, and the full-load range extends from the right up to the nominal range. If the throttling on the pressure side is increased, the blower passes from the full-load range through the nominal range, in particular the nominal point, as the throttling increases, and enters the overload range, wherein the delivery flow drops, while the difference between the inlet pressure and the outlet pressure rises.

In a preferred embodiment, the delivery device is configured, for example by configuring the design of the blower, such that the delivery-pressure-over-delivery-flow characteristic curve rises continuously up to and into the nominal range as the delivery flow decreases, and the pitch in the overload range, advantageously in the nominal range, decreases. Advantageously, the delivery-pressure-over-delivery-flow characteristic curve rises continuously up to at least the nominal point as the delivery flow decreases, and its pitch only decreases at the nominal point or only after it has passed through the nominal point as the throttling continues to increase and the delivery flow accordingly continues to decrease. The pitch of the characteristic curve can still be greater than zero throughout this flattened region of the characteristic curve or in one or more portions thereof. It is preferably smaller than 0.2 or smaller than 0.1 throughout the overload range, i.e. to the left of the nominal range or nominal point. The pitch can also turn negative as the throttling increases, such that the characteristic curve drops towards minimum delivery flow as the throttling increases.

While the use of side channel blowers and peripheral blowers as purge gas delivery devices is known in principle, such as for example from DE 197 09 903 A1 and DE 197 40 582 A1 mentioned at the beginning, the delivery device in accordance with an aspect of the invention is however particularly suitable for purging and by association regenerating filters for volatile fuel components, due to the flattening of its characteristic curve and by association its reduced power consumption at small delivery requirements, which includes a zero delivery requirement, since the blower can be operated at a reduced power consumption in operating phases of the engine in which no purge gas or only a very small proportion of purge gas is allowed to be mixed in with the fuel mixture. Side channel blowers and peripheral blowers exhibit significantly greater dynamics than radial blowers, since they typically operate at only around a third of the rotational speed of radial blowers. Due to its flattened characteristic curve, the blower of the delivery device in accordance with an aspect of the invention can be operated at higher rotational speeds than conventional side channel blowers and peripheral blowers in the lower rotational speed range in which it operates most of the time when used as a purge gas blower, such that it can be accelerated within a short space of time in the relatively short periods in which purge gas can be mixed in and a temporarily high delivery requirement accordingly exists. The blower of the delivery device in accordance with an aspect of the invention can thus be operated at a higher rotational speed than conventional side channel blowers and peripheral blowers when the requirement is low or zero and at a lower rotational speed than radial blowers when the delivery requirement is high. As viewed over its entire operating range, the spread of rotational speeds and consequently the response time in the event of a change in delivery requirement can be reduced.

In the lower rotational speed range (overload range), at zero delivery or only a small delivery, the impeller is operated at rotational speeds of less than 5,000 rpm or less than 3,000 rpm, for example at a rotational speed in the range of 1,000 to 2,000 rpm, in advantageous embodiments. In the upper rotational speed range (full-load range), at a large delivery requirement, it is operated at a rotational speed of advantageously at least 15,000 rpm and at most 25,000 rpm, preferably at a rotational speed of 20,000±2,000 rpm.

In order to flatten the delivery-pressure-over-delivery-flow characteristic curve, an aspect of the invention proposes several measures which can each be realised individually as alternatives to each other, or also together in different combinations.

In first embodiments, the blower exhibits a uniformly increased sealing gap between the channel walls of the interrupter channel and the paddle of the impeller which respectively passes through, over the circumferential length of the interrupter channel. The paddles and the interrupter channel form an axial sealing gap along the axially outer edge of the paddle on one or both end-facing sides of the respective paddle, and a radial sealing gap along the radially outer edge of the respective paddle, over the circumferential length and/or angular extent of the interrupter channel. The sealing gap, which is formed around a paddle which passes through the interrupter channel, extends from a base point of the respective paddle, along one axial edge of the paddle, then along the radially outer edge of the paddle and then along the other axial edge of the paddle up to the base point of the paddle on said other axial edge of the paddle.

The axial sealing gaps each exhibit an axial gap width, and the radial sealing gap exhibits a radial gap width. The axial gap width of one or also both of the axial sealing gaps can vary. If the axial gap width varies, it varies only monotonically over the length of the respective axial sealing gap in the radial direction, i.e. the respective axial sealing gap widens axially either from the radially inner side to the radially outer side or from the radially outer side to the radially inner side, but does not comprise any local projection, constriction or other type of recess. Preferably, each of the two axial sealing gaps exhibits a constant axial gap width over its entire length. The axial gap width of the two axial sealing gaps can be unequal or preferably equal. The overall sealing gap is preferably symmetrical in relation to the two axial sealing gaps. It also holds for the radial sealing gap that the latter's gap width, i.e. the radial gap width, is constant in preferred embodiments, but at any rate does not comprise any fin-shaped projections or groove-shaped recesses. The uniform increase in the sealing gap establishes a specific leakage via the interrupter channel towards the inlet region, wherein said leakage ensures that the delivery-pressure-over-delivery-flow characteristic curve flattens and as applicable instably drops towards minimum delivery flow and/or a theoretical zero delivery.

As discussed above, the sealing gap between the paddles and the channel walls of the interrupter channel is larger than would be required to ensure free movement of the impeller. The axial gap width on the left-hand end-facing side and/or right-hand end-facing side of the respective paddle and/or the radial gap width at the free radial end of the paddle can in particular correspond to at least a clearance fit between the paddle and the interrupter channel. Preferably, one or two of the gap widths and particularly preferably all three of the gap widths mentioned is/are each larger than would correspond to a clearance fit.

In relation to a maximum breadth of the paddles, the axial gap width of one or both of the axial sealing gaps and/or the radial gap width of the radial sealing gap can in particular measure at least 3% or at least 4% or at least 5% of the maximum paddle breadth, wherein the paddle breadth is measured parallel to the rotational axis of the impeller. In conventional side channel blowers and peripheral blowers from the automotive sector, the gap widths measure at most one or two tenths of a millimetre. In advantageous embodiments of the invention, the axial gap width of one or both of the axial sealing gaps and/or the radial gap width of the radial sealing gap measure(s) at least 3 (three) tenths of a millimetre or at least 4 (four) tenths of a millimetre or at least 5 (five) tenths of a millimetre. If the gap width varies over the length of the respective sealing gap, then the smallest gap width in the respective sealing gap advantageously measures at least 3 tenths of a millimetre or at least 4 tenths of a millimetre in such embodiments.

The uniform increase in the sealing gap can also be accurately characterised by the ratio between the area of the sealing gap and the effective area of the paddle. The area of the sealing gap is understood to be the area of the overall sealing gap projected into a longitudinal sectional plane of the rotor wheel in the rotational direction of the rotor wheel, wherein the rotational axis of the impeller extends in this longitudinal sectional plane. If the paddles are simply straight and extend exactly radially, the projection plane and the plane of the paddle coincide. If, however, the paddles point or invert obliquely with respect to the radial or are inclined roundly, this is not the case. Such paddles are as it were projected onto a planar paddle which points exactly radially. The effective area of the paddle is the area of the paddle over which the respective paddle acts on the medium to be delivered when the impeller is rotated in the rotational direction and thus generates an impulse in the rotational direction. The sealing gap extends over the entire outer edge of the paddle, providing the edge of the paddle surrounds the effective area of the paddle. If, for example, the respective paddle is inserted into a slot on the outer circumference of the impeller, the area of the paddle situated in the slot does not count as the effective area of the paddle. Similarly, the base point of the paddle is only understood to be a point on the area of the paddle directly on the outer circumference of the impeller. In advantageous embodiments, this ratio between the area of the sealing gap and the effective area of the paddle measures at least 0.06 or at least 0.07. For a good degree of effectiveness despite the specific leakage, the ratio between the area of the sealing gap and the effective area of the paddle advantageously measures at most 0.25 or at most 0.20.

As an alternative to or in addition to the ratios described above, the uniform increase in the sealing gap can be characterised by the ratio between the area of the sealing gap and the cross-sectional area of the interrupter channel which the paddles pass through when the impeller is rotated. In the longitudinal sectional plane mentioned above, the interrupter channel exhibits a free cross-sectional area which is limited laterally and on the radially outer side by the channel walls of the interrupter channel and on the radially inner side by a straight line which extends through the base point of the paddle on one axially outer edge of the paddle and through the base point of the paddle on the other axially outer edge of the paddle. The ratio between the area of the sealing gap and the cross-sectional area of the channel preferably measures at least 0.05 or at least 0.06. The ratio between the area of the sealing gap and the cross-sectional area of the channel can measure up to 0.20 or up to 0.15 and preferably up to at most 0.13.

Due to the uniform increase in the sealing gap in accordance with an aspect of the invention, the leakage flow flows in a uniform distribution along the edge of the paddle, advantageously in a uniform distribution over the entire free outer edge of the paddle, from the interrupter channel into the delivery channel. The leakage flow can for example be distributed around the paddles substantially in a U shape or a hemi-annular shape. A disruption to the flow in the upstream delivery portion of the delivery channel, near the inlet, is at least largely avoided. The formation of the rotational flow is even assisted, meaning that energy transmission begins significantly earlier. The delivery rate and the degree of effectiveness of the blower are significantly increased relative to a blower comprising a groove as the leakage path.

The “delivery pressure over delivery flow” delivery characteristic curve can also be flattened by means of a bypass which connects the high-pressure side of the blower to the low-pressure side of the blower by bypassing the interrupter channel, such that a leakage flow from the high-pressure side to the low-pressure side is established. The high-pressure side of the blower comprises a downstream portion of the delivery channel, whence it extends in the delivery direction via the outlet up to a closing and/or dosing member which succeeds the blower downstream or up to a consumer to which the medium to be delivered is supplied by means of the blower. The closing and/or dosing member can in particular be a dosing valve. The low-pressure side extends via the inlet up to and into the delivery channel and comprises an upstream portion of the delivery channel which adjoins the inlet in the delivery direction.

The bypass can be embodied as a passive bypass or as an active bypass or as applicable also as a hybrid form consisting of a passive and active bypass. If it is embodied as a passive bypass, the flow resistance of the bypass is established solely by the geometric configuration of the bypass, such that a leakage flow which is predetermined by means of the flow resistance ensures that the pressure characteristic curve flattens and preferably inverts. If it is embodied as an active bypass, a bypass valve is arranged in the bypass. When a threshold pressure predetermined by the bypass valve is exceeded, the bypass valve transitions abruptly, or continuously as the pressure continues to rise, from a state of minimum throughput to a state of maximum throughput.

The bypass can be realised in addition to or instead of the increased sealing gap.

In addition to or as an alternative to the increased sealing gap and/or the bypass, the “delivery pressure over delivery flow” delivery characteristic curve can be flattened by limiting the input power (shaft power). In this way, the delivery pressure can be limited in a desired operating range of the blower, preferably the overload range. It is for example possible to establish a delivery characteristic curve which assumes a maximum value at the nominal point and decreases steadily in the overload range. If the blower is driven by an electric motor, it is possible to limit the electric input power of the electric motor. In particular, the input current of the motor can be limited to a certain value, at a constant voltage. The hardware and/or software for limiting the electric input power can be installed and/or implemented within the delivery device or can be part of a controller placed elsewhere.

Another of the measures is to choose the paddle geometry. Several of the paddles and preferably all of the paddles can then comprise a convex rounded profile or an oblique chamfer, which extends in the circumferential direction, on at least one axially outer edge of the paddle and/or on the radially outer edge of the paddle. Alternatively or additionally, several of the paddles and preferably all of the paddles can comprise a radially outer edge of the paddle which in a plan view onto a front side of the respective paddle is convexly or concavely, for example roundly, arched radially inwards or radially outwards or is polygonal, for example trapezium-shaped, or rises monotonically from one end-facing side to the other. Alternatively or additionally, several of the paddles and preferably all of the paddles can comprise at least one paddle portion which points towards a rotational axis of the impeller in an axial view of the impeller at an inclination to a radial which extends through the respective paddle.

The “delivery pressure over delivery flow” characteristic curve can be flattened solely by the paddle geometry. In preferred embodiments, however, one or more of the measures relating to the paddle geometry is/are realised in combination with the measure of the increased sealing gap and/or the bypass and/or limiting the input power (shaft power).

Another measure is to embody the blower as a multi-flux, for example dual-flux blower. A multi-flux blower comprises a first delivery flux and a second delivery flux. The blower also comprises an outlet which is common to the two delivery fluxes or a first outlet for the first delivery flux and a second outlet for the second delivery flux, wherein the first outlet and the second outlet are connected to each other downstream of the respective delivery flux. The first and second delivery flux can differ from each other in their delivery-pressure-over-delivery-flow characteristic curve and thus in their delivery rate. The delivery fluxes are short-circuited via the outlet or the connected outlets. If they differ in their delivery rate, a backflow from the delivery flux having a greater delivery rate (the main flux or first flux) into the delivery flux having a lower delivery rate (the regulating flux or second flux) via the common outlet or the connected outlets occurs at least in certain operating states, preferably in the overload range. They preferably also comprise a common inlet or a first inlet for the first delivery flux and a second inlet for the second delivery flux, wherein the first inlet and the second inlet are connected to each other upstream of the respective delivery flux. In such embodiments, the delivery fluxes are connected in parallel. The fluxes can in particular be short-circuited or connected in parallel in or on the housing of the blower.

In a first variant of the multi-flux blower, a multi-flux impeller is used, preferably a dual-flux impeller comprising a left-hand delivery flux (the first flux) on one end-facing side of the impeller and a right-hand delivery flux (the second flux) on the other end-facing side of the impeller. The two delivery fluxes are separated from each other. They can be fluidically separated by a separating stay of the impeller which encircles the outer circumference of the impeller or by a separating stay of the housing which encircles the inner circumference of the housing. The separating stay extends axially between the left-hand delivery flux and the right-hand delivery flux. The delivery fluxes can comprise a common inlet which expediently emerges on the inner circumference of the housing which surrounds the impeller. Instead, however, they can also each comprise an assigned inlet, i.e. a left-hand inlet on a left-hand channel end-facing wall of the housing which faces the left-hand delivery flux and a right-hand inlet on a right-hand channel end-facing wall of the housing which faces the right-hand delivery flux. The left-hand inlet and the right-hand inlet can be connected to each other upstream of the delivery channel, i.e. a common supply can bifurcate to form the left-hand inlet and the right-hand inlet. The delivery fluxes can comprise a common outlet which expediently emerges on the inner circumference of the housing which surrounds the impeller. Instead, however, they can also each comprise an assigned outlet, i.e. a left-hand outlet on a left-hand channel end-facing wall of the housing which faces the left-hand delivery flux and a right-hand outlet on a right-hand channel end-facing wall of the housing which faces the right-hand delivery flux. The left-hand outlet and the right-hand outlet can be connected to each other downstream of the delivery channel, i.e. can converge to form a common drainage.

The left-hand delivery flux and the right-hand delivery flux can be embodied differently, by differentiating the paddle geometry and/or the channel geometry, i.e. the geometry of the delivery channel and/or the interrupter channel, on the left and on the right. In such variants, the left-hand delivery flux and the right-hand delivery flux differ in their delivery rate. In particular, one flux can generate a greater build-up of pressure than the other flux. The paddles of one flux can then for example be larger than the paddles of the other flux. One of the fluxes can comprise more paddles than the other. The delivery channel of one flux can be shaped differently in the longitudinal section of the blower and/or can be larger than the delivery channel of the other flux. The interrupter channel of one flux can be shaped differently in the longitudinal section of the blower and/or can be larger than the interrupter channel of the other flux. Other measures, for example disruptive geometries, for reducing the delivery rate can be implemented in one of the two delivery channels. The aim is to internally achieve a change in delivery in one of the two delivery fluxes with increasing throttling on the pressure side beyond a defined working state of the blower. In the region of the characteristic curve exhibiting an effective difference in pressure between the two fluxes, the delivery flux having a higher delivery rate flows through the delivery flux having a lower delivery rate, counter to the rotational direction of the impeller. A backflow from the delivery flux having a higher delivery rate into the delivery flux having a lower delivery rate occurs via the common outlet or the connected outlets. This causes the build-up of pressure to drop and the “delivery pressure over delivery flow” delivery characteristic curve to flatten, and preferably invert, in a defined way.

In a second variant of the multi-flux blower, the blower comprises a main flux (the first delivery flux) and additionally a regulating flux (the second delivery flux). The main flux and the regulating flux are formed in the housing of the blower. The impeller is part of the main flux. The regulating flux is embodied to be smaller than the main flux.

The impeller can comprise an additional paddle ring with which it forms the regulating flux. Alternatively, the regulating flux can comprise an additional impeller comprising paddles, wherein the additional impeller can be arranged alongside the impeller of the main flux on the same shaft. If the additional paddle ring is arranged on the impeller of the main flux, said impeller can comprise the paddle ring of the regulating flux, axially level and radially within the paddle ring of the main flux or axially offset with respect to the paddle ring of the main flux, on an outer circumference, for example an outer circumference having a smaller diameter.

As described further above with respect to the first variant, the main flux and the regulating flux can comprise a common inlet. Instead, however, they can also each comprise an assigned inlet, i.e. one inlet for the main flux and another inlet for the regulating flux. The inlet of the main flux and the inlet of the regulating flux can be connected to each other upstream of the delivery channel, i.e. a common supply can bifurcate to form the inlet of the main flux and the inlet of the regulating flux. The main flux and the regulating flux can comprise a common outlet. Instead, however, they can also each comprise an assigned outlet, i.e. one outlet for the main flux and one outlet for the regulating flux, wherein the outlet of the main flux and the outlet of the regulating flux can be connected to each other downstream of the respective delivery channel, i.e. can converge to form a common drainage.

The regulating flux is characterised by a flatter profile of its “delivery pressure over delivery flow” characteristic curve than the main flux. In a region of the characteristic curve around the nominal point, a change in delivery occurs and the regulating flux is circulated counter to the rotational direction. Beyond a certain delivery pressure corresponding to said change, the regulating flux acts as a bypass and causes the “delivery pressure over delivery flow” characteristic curve of the main flux to be flattened, and preferably inverted, in a defined way.

In a third variant of the multi-flux blower, a first delivery channel (the first flux) and a second delivery channel (the second delivery flux) are arranged one behind the other in the circumferential direction in the housing of the blower, and the impeller passes through them one after the other. A first delivery flux is obtained via the angular extent of the first delivery channel, and a second delivery flux is obtained via the angular extent of the second delivery channel. The delivery fluxes differ in terms of their delivery rate. For this purpose, the delivery channels can in particular be different. One of the delivery channels can thus extend around the rotational axis over a greater angle than the other, and/or one of the delivery channels can have a larger cross-section than the other, and/or one or more measures for reducing the delivery rate can be implemented in one of the delivery channels.

The delivery channels arranged one behind the other are short-circuited in relation to the outlet. They are preferably connected in parallel. The delivery channels arranged one behind the other either comprise a common outlet or instead each comprise an assigned outlet, i.e. a first outlet for the first delivery channel and a second outlet for the second delivery channel. If they comprise the first outlet and the second outlet, the latter are connected to each other downstream of the respective delivery channel, i.e. they converge to form a common drainage. In the variant comprising delivery channels arranged one behind the other and, correspondingly, delivery fluxes arranged one behind the other, a backflow into the delivery channel having the lower delivery rate again occurs via the outlet, and consequently the “delivery pressure over delivery flow” characteristic curve is flattened, and preferably inverted, in a defined way. If connected in parallel, the delivery channels arranged one behind the other either comprise a common inlet or each comprise an assigned inlet, i.e. a first inlet for the first delivery channel and a second inlet for the second delivery channel. If they comprise the first inlet and the second inlet, the latter are connected to each other upstream of the delivery channels, i.e. a common supply bifurcates to form the first inlet and the second inlet.

In an advantageous embodiment, the delivery device comprises a dosing valve and a controller or regulator which is configured to control and/or regulate the blower, in particular the impeller, in terms of its rotational speed and the dosing valve in terms of its valve state, i.e. in terms of its throughput. The dosing valve can be switched between a state of minimum throughput, which is preferably a closed state, and a state of maximum throughput. In a first variant, the valve can be switched between discrete switched states, i.e. it is a switching valve. In a second variant, it is embodied as a proportional valve and allows a steady, continuous alteration of the valve opening which governs the throughput. The dosing valve can in particular be an electromagnetic switching valve or proportional valve, for example a pulse-width-modulated valve. The pulse-width-modulated dosing valve can for example be operated at a clock frequency of at least 5 Hz or at least 10 Hz. Clock frequencies in the range of 8 to 12 Hz, for example 10 Hz, are preferred.

The controller or regulator can be configured to set the dosing valve to a state of large throughput, expediently a state of maximum throughput, when the requirement for medium to be delivered is high and to control and/or regulate the delivery flow by varying the rotational speed of the blower in the upper rotational speed range of for example 15,000 to 25,000 rpm and to operate the blower in the lower rotational speed range of for example at most 5,000 or at most 3,000 rpm when the requirement is low, preferably at an at least substantially constant rotational speed in the lower rotational speed range, and to set the delivery rate by varying the valve state. For rapid acceleration when demand rises, the blower is advantageously not brought to a stop in its low-requirement operating state but rather operated at a rotational speed of at least 300 rpm or at least 500 rpm. If the delivery rate is set by means of the dosing valve, the difference in pressure as measured across the dosing valve in a closed valve state is advantageously small. In advantageous embodiments, the blower is operated in this operating state at a rotational speed which ensures that said difference in pressure on the dosing valve measures at most 0.5 bars or at most 0.3 bars or at most 0.2 bars.

The principle of changing between “fulfilling the delivery requirement by varying the rotational speed of the blower in the upper rotational speed range according to requirement, with the dosing valve open” when the delivery requirement is large and “fulfilling the delivery requirement by varying the valve state and operating the blower in the lower rotational speed range” when the delivery requirement is low can be combined with any of the other measures disclosed herein. The principle is however also advantageous in its own right, without flattening the “delivery pressure over delivery flow” characteristic curve as claimed herein. The Applicant therefore reserves the right to direct an independent application to this, even without Feature 1.3 of claim 1.

Features of the invention are also described in the aspects formulated below. The aspects are worded in the manner of claims and can substitute for them. Features disclosed in the aspects can also supplement and/or qualify the claims as well as the measures described above, indicate alternatives with respect to individual features and/or broaden claim features. Bracketed reference signs refer to example embodiments of the invention which are illustrated below in figures. They do not restrict the features described in the aspects to their literal sense as such, but do conversely indicate preferred ways of realising the respective feature.
Aspect 1. A delivery device for a medium to be delivered, for example for purging a filter for volatile fuel components, comprising a blower (B), which is embodied as a side channel blower or peripheral blower, and optionally an electric drive motor (25) for the blower, the blower (B) comprising:
   1.1 a housing (1, 2), comprising: an inlet (3) and an outlet (4) for the medium to be delivered, for example purge air; a delivery channel (5) which extends in the circumferential direction and comprises a side channel (6, 7); and an interrupter channel (8; 9) which extends in the circumferential direction for separating the inlet (3) and the outlet (4); and
   1.2 an impeller (10) which can rotate in the housing (1, 2) about a rotational axis (R) and comprises paddles (13) which, when the impeller is rotated, pass through the delivery channel (5) and the interrupter channel (8; 9),
   1.3 wherein the delivery device is optionally configured such that the delivery-pressure-over-delivery-flow characteristic curve of the delivery device or the blower (B) flattens or drops towards minimum delivery flow.
Aspect 2. The delivery device according to the preceding aspect, wherein the paddles (13) and the interrupter channel (9) form an axial sealing gap (21, 23) along the axially outer edge of the paddle on one or both end-facing sides of the respective paddle (13), exhibiting an axial gap width (Wₐ) which is constant or increases only monotonically, preferably linearly, and progressing radially, and a radial sealing gap (22) exhibiting a radial gap width (Wᵣ) along the radially outer edge of the respective paddle (13), over the angular extent of the interrupter channel (8), wherein the axial gap width (Wₐ) and/or the radial gap width (Wᵣ) is/are of a size such that a specific leakage via the interrupter channel (9) is established and the delivery-pressure-over-delivery-flow characteristic curve flattens or drops towards minimum delivery flow.
Aspect 3. The delivery device according to any one of the preceding aspects, wherein the paddles (13) and the interrupter channel (9) form an axial sealing gap (21, 23) exhibiting an axial gap width (Wₐ) along the axially outer edge of the paddle on one or both end-facing sides of the respective paddle (13), and a radial sealing gap (22) exhibiting a radial gap width (Wᵣ) along the radially outer edge of the respective paddle (13), over the angular extent of the interrupter channel (9), wherein the axial gap width (Wₐ) and/or the radial gap width (Wᵣ) is/are larger than a clearance fit between the paddle (13) and the interrupter channel (9).
Aspect 4. The delivery device according to any one of the preceding aspects, wherein the paddles (13) and the interrupter channel (9) form an axial sealing gap (21, 23) exhibiting an axial gap width (Wₐ) along the axially outer edge of the paddle on one or both end-facing sides of the respective paddle (13), and a radial sealing gap (22) exhibiting a radial gap width (Wᵣ) along the radially outer edge of the respective paddle (13), over the angular extent of the interrupter channel (9), wherein the axial gap width (Wₐ) along the axial edge of the paddle measures more than 3%, preferably more than 4%, of the axially measured paddle breadth throughout, and/or the radial gap width (Wᵣ) along the radial edge of the paddle measures more than 3%, preferably more than 4%, of the radially measured paddle length throughout.
Aspect 5. The delivery device according to any one of the preceding aspects, wherein the paddles (13) and the interrupter channel (9) form a sealing gap (20) along an outer edge of the paddle over the angular extent of the interrupter channel (9), wherein the sealing gap (20) exhibits a gap width (Wₐ, Wᵣ) along the axially outer edge of the paddle on one or both end-facing sides of the respective paddle (13), and/or along the radially outer edge of the respective paddle (13), which is larger than is required for free movement of the impeller (10).
Aspect 6. The delivery device according to any one of the immediately preceding four aspects, wherein the axial gap width (Wₐ) and/or the radial gap width (Wᵣ) is/are constant along one of both end-facing sides and/or along the outer circumference of the respective paddle (13) or increases only monotonically, preferably linearly, or decreases only monotonically, preferably linearly, along the respective sealing gap (21, 22, 23).
Aspect 7. The delivery device according to any one of the preceding aspects, wherein the impeller (10) and the interrupter channel (9) limit an axial sealing gap (10a) over the angular extent of the interrupter channel (9), in order to seal off the interrupter channel (9) towards the radially outer side, and said axial sealing gap (10a) widens axially at a base point (14, 15) of the paddle or on the radially outer side of the base point (14, 15) of the paddle on the axially outer edge of the respective paddle (13), such that an increased axial sealing gap (21, 23) between the respective paddle (13) and the interrupter channel (9) is obtained.
Aspect 8. The delivery device according to the preceding aspect, wherein the axial sealing gap (10a) which is limited by the impeller (10) and the interrupter channel (9) over the angular extent of the interrupter channel (9) widens axially at the base point (14, 15) of the respective paddle (13), such that the increased axial sealing gap (21, 23) begins at the base point of the paddle.
Aspect 9. The delivery device according to any one of the immediately preceding seven aspects, wherein the axial sealing gap (10a) which is limited by the impeller (10) and the interrupter channel (9) over the angular extent of the interrupter channel (9) abruptly widens axially into the increased axial sealing gap (21, 23), forming a collar which is advantageously formed on an end-facing side of the housing (1, 2) of the blower.
Aspect 10. The delivery device according to any one of the preceding aspects, wherein:
   the impeller (10) comprises an outer circumference from which the paddles (13) protrude radially outwards;
   the paddles (13) each comprise an outer edge which extends from an axially left-hand base point (14) of the paddle on the outer circumference of the impeller (10) up to an axially right-hand base point (15) of the paddle on the outer circumference of the impeller (10) via a radially outer circumference of the respective paddle (13);
   the interrupter channel (9) and the respective paddle (13) form a sealing gap (20) which extends around the outer edge of the paddle from the left-hand base point (14) of the paddle up to the right-hand base point (15) of the paddle;
   the sealing gap (20) exhibits an area (A_{SG}), as projected into a longitudinal sectional plane of the impeller (10) in the rotational direction of the impeller (10), wherein the rotational axis (R) of the impeller (10) extends in this longitudinal sectional plane;
   the respective paddle (13) exhibits an effective area (A_{P}), as projected into said longitudinal sectional plane in the rotational direction; and
   the ratio (A_{SG}/A_{P}) between the area of the sealing gap and the effective area of the paddle measures at least 0.06 or at least 0.07 or at least 0.08.
Aspect 11. The delivery device according to the preceding aspect, wherein the ratio (A_{SG}/A_{P}) between the area of the sealing gap and the effective area of the paddle measures at most 0.25 or at most 0.20.
Aspect 12. The delivery device according to any one of the preceding aspects, wherein:
   the impeller (10) comprises an outer circumference from which the paddles (13) protrude radially outwards;
   the paddles (13) each comprise an outer edge which extends from an axially left-hand base point (14) of the paddle on the outer circumference of the impeller (10) up to an axially right-hand base point (15) of the paddle on the outer circumference of the impeller (10) via a radially outer circumference of the respective paddle (13);
   the interrupter channel (9) and the respective paddle (13) form a sealing gap (20) which extends around the outer edge of the paddle from the left-hand base point (14) of the paddle up to the right-hand base point (15) of the paddle;
   the sealing gap (20) exhibits an area (A_{SG}), as projected into a longitudinal sectional plane of the impeller (10) in the rotational direction of the impeller (10), wherein the rotational axis (R) of the impeller (10) extends in this longitudinal sectional plane;
   the interrupter channel (9) exhibits, in the same longitudinal sectional plane, a free cross-sectional area (A_{IC}) which is limited laterally and on the radially outer side by the channel walls of the interrupter channel (9) and on the radially inner side by a straight line which extends through the left-hand base point (14) of the paddle and through the right-hand base point (15) of the paddle; and
   the ratio (A_{SG}/A_{IC}) between the area of the sealing gap and the cross-sectional area of the channel measures at least 0.05 or at least 0.06.
Aspect 13. The delivery device according to the preceding aspect, wherein the ratio (A_{SG}/A_{IC}) between the area of the sealing gap and the cross-sectional area of the channel measures at most 0.20 or at most 0.15.
Aspect 14. The delivery device according to any one of Aspects 2 to 13, wherein the sealing gap (20) which is limited by the respective paddle (13) and the interrupter channel (9) exhibits a constant axial width (Wₐ) axially to the left and right of the respective paddle (13) or increases only monotonically, preferably linearly, or decreases only monotonically, preferably linearly, radially outwards from the respective base point (14, 17).
Aspect 15. The delivery device according to any one of the preceding aspects, wherein the interrupter channel (9) does not comprise any recesses on its side walls which axially face each other.
Aspect 16. The delivery device according to any one of the preceding aspects, wherein the paddles (13) do not comprise any axial recess or constriction on their outer edge.
Aspect 17. The delivery device according to any one of the preceding aspects except Aspect 15, wherein the interrupter channel (8) comprises one or more recesses, such as for example one or more grooves, on at least one of its side walls which axially face each other and/or in a circumference wall of the channel which surrounds the impeller (10) on the radially outer circumference of the paddles (13).
Aspect 18. The delivery device according to any one of the preceding aspects except Aspect 16, wherein several of the paddles (13) and preferably all of the paddles (13) each comprise a constriction on at least one axial end-facing side and/or on the radially outer circumference.
Aspect 19. The delivery device according to any one of the preceding aspects, wherein the paddles (13) comprise a convex rounded profile (16) or an oblique chamfer (17), which extends in the circumferential direction, on at least one axially outer edge of the paddle and/or on the radially outer edge of the paddle.
Aspect 20. The delivery device according to the preceding aspect, wherein the respective paddle (13) is chamfered or convexly rounded in the circumferential direction, in portions only, on the respective axially outer edge of the paddle and/or on the radially outer edge of the paddle.
Aspect 21. The delivery device according to any one of the immediately preceding two aspects, wherein the respective paddle (13) comprises the rounded profile (16) or chamfer (17) on a front side of the paddle which is a leading side in relation to the rotational direction or a primary rotational direction of the impeller (10).
Aspect 22. The delivery device according to any one of the immediately preceding three aspects, wherein the respective paddle (13) comprises the rounded profile (16) or chamfer (17) on a rear side of the paddle which is a trailing side in relation to the rotational direction or a primary rotational direction of the impeller (10).
Aspect 23. The delivery device according to any one of the immediately preceding four aspects, wherein the respective paddle (13) comprises the rounded profile (16) or chamfer (17) on a front side of the paddle which is a leading side in relation to the rotational direction or a primary rotational direction of the impeller (10) and also comprises another convex rounded profile (16) or oblique chamfer (17), which extends in the circumferential direction, on a rear side of the paddle which is a trailing side in relation to the rotational direction or a primary rotational direction of the impeller (10).
Aspect 24. The delivery device according to any one of the immediately preceding five aspects, wherein the convex rounded profile (16) is composed of a convex rounded portion which points in the rotational direction of the impeller (10) and a convex rounded portion which points counter to the rotational direction, wherein the rounded profile composed in this way can be steadily differentiated over its entire profile.
Aspect 25. The delivery device according to any one of the immediately preceding six aspects, wherein the respective paddle (13) comprises the rounded profile (16) or chamfer (17) on one axially outer edge of the paddle only or on both axially outer edges of the paddle or on the radially outer edge of the paddle only, in the circumferential direction.
Aspect 26. The delivery device according to any one of Aspects 19 to 24, wherein the respective paddle (13) comprises the rounded profile (16) or chamfer (17) on both axially outer edges of the paddle or on the radially outer edge of the paddle.
Aspect 27. The delivery device according to any one of the preceding aspects, wherein several of the paddles (13) and preferably all of the paddles (13) comprise a radially outer edge (18) which in a plan view onto a front side of the respective paddle (13) is convexly or concavely, for example roundly, arched radially inwards or radially outwards proceeding from both axial end-facing sides or is polygonal, for example trapezium-shaped.
Aspect 28. The delivery device according to any one of Aspects 19 to 26, wherein several of the paddles (13) and preferably all of the paddles (13) comprise a radially outer edge (18) which in a plan view onto a front side of the respective paddle (13) monotonically rises obliquely or roundly from one axial end-facing side to the other axial end-facing side of the respective paddle (13).
Aspect 29. The delivery device according to any one of the preceding aspects, wherein several of the paddles (13) and preferably all of the paddles (13) comprise at least one paddle portion (19) which points towards a rotational axis (R) of the impeller (10) in an axial view of the impeller (10) at an inclination (ϕ) to a radial which extends through the respective paddle (13).
Aspect 30. The delivery device according to the preceding aspect, wherein the respective paddle (13) or respective paddle portion (19) is inclined in the forward direction in relation to the rotational direction or a primary rotational direction of the impeller (10).
Aspect 31. The delivery device according to any one of the immediately preceding two aspects, wherein the respective paddle (13) comprises a concave front side in the axial view in relation to the rotational direction or a primary rotational direction of the impeller (10).
Aspect 32. The delivery device according to any one of the immediately preceding three aspects, wherein the respective paddle (13) inverts one or more times and preferably inverts one or more times in the forward direction in relation to the rotational direction or a primary rotational direction of the impeller (10).
Aspect 33. The delivery device according to any one of the immediately preceding four aspects, wherein the respective paddle (13) is curved, at least in portions, continuously in the forward direction.
Aspect 34. The delivery device according to any one of the immediately preceding five aspects, wherein the inclination (ϕ)) measures at least 10° or at least 20° and/or at most 60° or at most 50°.
Aspect 35. The delivery device according to any one of the preceding aspects, comprising a bypass (30; 40a; 40b) which connects a high-pressure side of the blower (B) to a low-pressure side of the blower (B) by bypassing the interrupter channel (8), wherein the high-pressure side extends from the delivery channel (5) via the outlet (4) up to a closing or dosing member (106) which succeeds the blower (B) downstream of the blower (B) and is preferably a dosing valve (106), and the low-pressure side extends via the inlet (3) up to and into the delivery channel (5).
Aspect 36. The delivery device according to any one of the preceding aspects, comprising a bypass (30; 40a; 40b) which connects the outlet (4) or a downstream delivery portion (5c) of the delivery channel (5) near the outlet (4) to the inlet (3) or an upstream delivery portion (5a) of the delivery channel (5) near the inlet (3) by bypassing the interrupter channel (8).
Aspect 37. The delivery device according to the preceding aspect, wherein the bypass (30; 40a; 40b) leads through the housing (1, 2) of the blower (B) and optionally through a motor housing (26) of the electric motor (25) if the delivery device comprises one.
Aspect 38. The delivery device according to any one of the immediately preceding three aspects, wherein the bypass (30; 40a; 40b) extends from a divergence opening (31; 41), which branches off from the downstream delivery portion (5c) of the delivery channel (5) or from the outlet (4), up to a convergence opening (35; 45) which emerges in the upstream delivery portion (5a) of the delivery channel (5) or in the inlet (3).
Aspect 39. The delivery device according to any one of the immediately preceding four aspects, comprising the electric drive motor (25) which comprises a motor housing (26), wherein the motor housing (26) is joined to the housing (1, 2) of the blower (B), or the housing (1, 2) of the blower (B) is axially elongated in order to simultaneously also form the motor housing (26), such that the drive motor (25) and the blower (B) form a fitted unit, and wherein the bypass (30; 40a; 40b) is self-contained in the fitted unit.
Aspect 40. The delivery device according to any one of the immediately preceding five aspects, wherein the bypass (30; 40a; 40b) leads through the housing (1, 2) of the blower (B) alongside the interrupter channel (8), preferably alongside the interrupter channel (8) in an axial plan view.
Aspect 41. The delivery device according to any one of the immediately preceding six aspects, comprising the electric drive motor (25) which is arranged on the blower (B) and comprises a stator (28), a rotor (27) and a motor housing (26) which surrounds the stator and the rotor, wherein a branch (36, 37, 38) of the bypass (30) leads through the motor housing (26).
Aspect 42. The delivery device according to any one of the immediately preceding seven aspects, wherein the bypass (30) as a whole or only a branch (31-35) of the bypass (30) extends axially between end-facing sides of the housing (1, 2) of the blower (B) and the impeller (10) which directly face each other.
Aspect 43. The delivery device according to any one of the immediately preceding eight aspects, wherein the bypass (30) emerges into the delivery channel (5), preferably into the side channel (6), downstream of the inlet (3).
Aspect 44. The delivery device according to any one of the immediately preceding nine aspects, wherein the bypass (30) branches off from the delivery channel (5), preferably from the side channel (6), upstream of the outlet (4).
Aspect 45. The delivery device according to any one of the preceding aspects, comprising:
   a divergence opening (31) which is provided downstream of an intermediate delivery portion (5b) of the delivery channel (5) which extends in the circumferential direction, in a downstream delivery portion (5c) of the blower (B) which extends from the intermediate delivery portion (5b) up to the interrupter channel (8);
   an convergence opening (35) which is provided upstream of the intermediate delivery portion (5b) in an upstream delivery portion (5a) of the blower (B) which extends from the interrupter channel (8) up to the intermediate delivery portion (5b); and
   a bypass (30) which connects the divergence opening (31) to the convergence opening (35) in order to reduce the pressure at the outlet (4) of the blower (B) when the delivery flow is at a minimum.
Aspect 46. The delivery device according to the preceding aspect, wherein the intermediate delivery portion (5b) has an angular extent (13) of at least 45° or at least 90° or at least 120° in the circumferential direction in relation to the rotational axis (R) of the impeller (10).
Aspect 47. The delivery device according to any one of the immediately preceding two aspects, wherein the downstream delivery portion (5c) in which the divergence opening (31) emerges has an angular extent (γ) of at most 120° or at most 90° or at most 70° in the circumferential direction in relation to the rotational axis (R) of the impeller (10), proceeding from the interrupter channel (8).
Aspect 48. The delivery device according to any one of the immediately preceding three aspects, wherein the upstream delivery portion (5a) into which the convergence opening (35) emerges has an angular extent (a) of at most 60° or at most 45° in the circumferential direction, proceeding from the interrupter channel (8).
Aspect 49. The delivery device according to any one of the immediately preceding four aspects, wherein the divergence opening (31) is provided in the delivery channel (5), preferably in the side channel (6).
Aspect 50. The delivery device according to any one of the immediately preceding five aspects, wherein the convergence opening (35) is provided in the delivery channel (5), preferably in the side channel (6).
Aspect 51. The delivery device according to any one of Aspects 35 to 50, wherein the bypass (30) comprises at least one bypass portion (32, 34) which is formed as a recess in an end-facing surface of the housing (1, 2) which faces the impeller (10).
Aspect 52. The delivery device according to any one of Aspects 35 to 51, comprising a shaft for rotary-driving the impeller (10), wherein the bypass (30) comprises a central bypass portion (33) which extends around the shaft.
Aspect 53. The delivery device according to any one of Aspects 35 to 52, wherein a bypass valve (43) is arranged in the bypass (40a; 40b), and the bypass valve (43) permits a flow through the bypass (40a; 40b) when the pressure of the medium to be delivered on the high-pressure side, for example in the downstream delivery portion (5c) of the delivery channel (5) or at the outlet (4), exceeds a predetermined threshold pressure.
Aspect 54. The delivery device according to the preceding aspect, wherein the bypass valve (43) is configured such that it blocks the bypass (40a; 40b) when the pressure on the high-pressure side falls below the threshold pressure.
Aspect 55. The delivery device according to any one of the immediately preceding two aspects, wherein the threshold pressure is a difference in pressure between a pressure of the high-pressure side and a pressure of the low-pressure side.
Aspect 56. The delivery device according to any one of the immediately preceding three aspects, wherein the threshold pressure measures at least 80% or at least 90% of the nominal delivery pressure (the delivery pressure at the nominal delivery point NP) of the blower (B).
Aspect 57. The delivery device according to any one of the immediately preceding four aspects, wherein the threshold pressure measures at most 120% or at most 110% of the nominal delivery pressure (the delivery pressure at the nominal delivery point NP) of the blower (B).
Aspect 58. The delivery device according to any one of the immediately preceding five aspects, wherein the delivery pressure at the nominal delivery point (NP) of the blower (B) forms the threshold pressure.
Aspect 59. The delivery device according to any one of the immediately preceding six aspects, wherein the bypass valve (43) comprises a valve element (46), which can be moved back and forth between a position of minimum throughput and a position of maximum throughput, and a valve spring (47) for generating a spring force which acts on the valve element (46) towards the position of minimum throughput, and the bypass valve (43) is arranged such that a pressure of the high-pressure side acts on the valve element (46) towards the position of maximum throughput.
Aspect 60. The delivery device according to the preceding aspect, wherein the bypass valve (43) comprises a spring space (49) in which the valve spring (47) is arranged, and the bypass (40a; 40b) leads through the spring space (49) when the bypass valve (43) is open.
Aspect 61. The delivery device according to any one of the immediately preceding eight aspects, wherein the bypass valve (43) is embodied as a reflux valve.
Aspect 62. The delivery device according to any one of the immediately preceding nine aspects, wherein the bypass (40a; 40b) comprises:
   a divergence opening (41) which is provided downstream of an intermediate delivery portion of the delivery channel (5) which extends in the circumferential direction, in a downstream delivery portion of the blower (B) which extends from the intermediate delivery portion up to and including the outlet (4); and
   an convergence opening (45) which is provided upstream of the intermediate delivery portion in an upstream delivery portion of the blower (B) which extends from the inlet (3) up to and including the intermediate delivery portion,
   wherein the bypass valve (43) is arranged between the divergence opening (41) and the convergence opening (45) and is configured to permit a throughput from the divergence opening (41) to the convergence opening (45) by bypassing the interrupter channel (8) when the threshold pressure is exceeded.
Aspect 63. The delivery device according to any one of the immediately preceding ten aspects, wherein the bypass valve (43) is arranged in or on the housing (1, 2) of the blower (B) or in or on a motor housing (26) of the drive motor (25), if provided.
Aspect 64. The delivery device according to any one of the preceding aspects, comprising the electric drive motor (25) and a power limiter, preferably a current limiter, for limiting the electric power which can be supplied to the drive motor (25) to a maximum electric power, preferably limiting the electric current (I) to a maximum current.
Aspect 65. The delivery device according to the preceding aspect, wherein the blower (B), the drive motor (25) and the power limiter are arranged in a common housing (1, 2, 26) of the delivery device.
Aspect 66. The delivery device according to Aspect 64, wherein the power limiter is arranged separately from the blower (B) and the drive motor (25) or is designed to be arranged separately.
Aspect 67. The delivery device according to any one of the immediately preceding three aspects, wherein the power limiter is part of a controller or regulator (113) which is coupled to the drive motor (25).
Aspect 68. The delivery device according to any one of the immediately preceding four aspects, wherein the power limiter is configured to limit the electric power to at most 120% or at most 110% of the electric power for delivery at the nominal point (NP) and preferably to limit it to the electric power for delivery at the nominal point (NP).
Aspect 69. The delivery device according to the preceding aspect, wherein the power limiter is configured to limit the electric power to a level below the electric power for delivery at the nominal point (NP).
Aspect 70. The delivery device according to any one of the immediately preceding six aspects, wherein the power limiter is configured to limit the electric power to at least 80% or at least 90% of the electric power for delivery at the nominal point (NP).
Aspect 71. The delivery device according to any one of the immediately preceding seven aspects, wherein the power limiter is configured to set the maximum power as a function of the rotational speed of the drive motor (25).
Aspect 72. The delivery device according to any one of the preceding aspects, wherein the blower (B) comprises a first delivery flux and a second delivery flux and an outlet which is common to the two delivery fluxes or instead a first outlet for the first delivery flux and a second outlet for the second delivery flux, wherein the first outlet and the second outlet are connected to each other downstream of the respective delivery flux.
Aspect 73. The delivery device according to the preceding aspect, wherein the first outlet and the second outlet are connected to each other while still within the housing (1, 2) of the blower (B).
Aspect 74. The delivery device according to any one of the immediately preceding two aspects, comprising an inlet which is common to the two delivery fluxes or instead a first inlet for the first delivery flux and a second inlet for the second delivery flux, wherein the first inlet and the second inlet are connected to each other upstream of the respective delivery flux.
Aspect 75. The delivery device according to the preceding aspect, wherein the first inlet and the second inlet branch off from a common supply while still within the housing (1, 2) of the blower (B).
Aspect 76. The delivery device according to any one of the immediately preceding four aspects, wherein the delivery fluxes differ in their delivery-pressure-over-delivery-flow characteristic curve and thus in their delivery rate, such that when a predetermined differential pressure is exceeded at the common outlet or at the connected outlets, a backflow from the delivery flux having a higher delivery rate into the delivery flux having a lower delivery rate occurs via the common outlet or the connected outlets.
Aspect 77. The delivery device according to any one of the preceding aspects, comprising the electric drive motor (25) and a controller or regulator (113) for controlling or regulating the drive motor (25) and preferably for supplying the drive motor (25) with a constant electric voltage and controlling or regulating the strength of the electric current (I).
Aspect 78. The delivery device according to any one of the preceding aspects, comprising the electric drive motor (25) and a controller or regulator (113) for controlling or regulating the rotational speed of the drive motor (25).
Aspect 79. The delivery device according to any one of the immediately preceding two aspects, wherein the delivery device is arranged in a motor vehicle or is designed to be installed in a motor vehicle, and the controller or regulator (113) is an integrated part of a superordinate engine controller of the motor vehicle.
Aspect 80. The delivery device according to Aspect 77 or Aspect 78, wherein the delivery device is arranged in a motor vehicle or is designed to be installed in a motor vehicle, and the controller or regulator (113) is arranged separately from a superordinate engine controller of the motor vehicle and comprises a signal input for connecting to the superordinate engine controller.
Aspect 81. The delivery device according to any one of the immediately preceding four aspects, wherein the controller or regulator (113) is configured to operate the blower (B) at a rotational speed of at most 25,000 rpm or at most 20.000 rpm.
Aspect 82. The delivery device according to any one of the immediately preceding five aspects, wherein the controller or regulator (113) is configured to operate the blower (B) steadily at a rotational speed of more than 500 rpm.
Aspect 83. The delivery device according to any one of the immediately preceding six aspects, comprising a dosing member (106), preferably a dosing valve (106), which is connected to the blower (B) and can be adjusted by means of the controller or regulator (113) between a state of minimum throughput, which can in particular be a closed state, and a state of maximum throughput.
Aspect 84. The delivery device according to the preceding aspect, wherein the dosing member (106) is arranged on the high-pressure side of the blower (B).
Aspect 85. The delivery device according to any one of the preceding two aspects, wherein the dosing member (106) is arranged downstream of and separately from the blower (B).
Aspect 86. The delivery device according to Aspect 83 or Aspect 84, wherein the dosing member (106) is arranged on the housing (1, 2) of the blower (B) or in the outlet (4) or directly at the outlet (4) of the blower (B) and still within the housing (1, 2) of the blower (B).
Aspect 87. The delivery device according to any one of the immediately preceding four aspects, wherein the controller or regulator (113) is configured to operate the blower (B) in a lower rotational speed range of at most 5,000 rpm or at most 3,000 rpm when a predetermined threshold requirement of medium to be delivered is undercut, and to set the volume flow of the medium to be delivered by means of the dosing member (106).
Aspect 88. The delivery device according to any one of the immediately preceding five aspects, wherein the controller or regulator (113) is configured to operate the blower (B) in an upper rotational speed range of at least 10,000 rpm or at least 15,000 rpm when a predetermined threshold requirement of medium to be delivered is exceeded, and to set the dosing member (106) to a maximum throughput.
Aspect 89. The delivery device according to any one of Aspects 77 to 88, comprising a sensor (112) for detecting a mass flow or volume flow delivered by the blower (B) and/or a pressure and/or temperature of the medium to be delivered, wherein the sensor (112) is coupled to the controller or regulator (113) in order to be able to input the measured mass flow or volume flow or pressure or temperature, as an actual value for regulating the blower (B) and/or dosing member (106), to the controller or regulator (113).
Aspect 90. The delivery device according to the preceding aspect, wherein the sensor (112) is arranged on the high-pressure side of the blower (B).
Aspect 91. The delivery device according to any one of the preceding two aspects, wherein the sensor (112) is arranged downstream of and separately from the blower (B).
Aspect 92. The delivery device according to Aspect 89 or Aspect 90, wherein the sensor (112) is arranged on the housing (1, 2) of the blower (B) or in the outlet (4) or directly at the outlet (4) of the blower (B) and still within the housing (1, 2) of the blower (B).
Aspect 93. The delivery device according to any one of Aspects 77 to 92, comprising a shut-off safety valve (105) for shutting off a fluid connection, preferably a venting conduit (101), which connects a fuel tank (100) to a suction region (107) of a combustion engine (110).
Aspect 94. The delivery device according to the preceding aspect, wherein the shut-off safety valve (105) is arranged on the low-pressure side of the blower (B) and separately from the blower (B) or on the housing (1, 2) of the blower (B) or in the inlet (3) or directly at the inlet (3) and already within the housing (1, 2) of the blower (B).
Aspect 95. The delivery device according to any one of the immediately preceding two aspects, wherein the shut-off safety valve (105) is coupled to the controller or regulator (113) or to a superordinate controller, for example an engine controller of a motor vehicle, such that the controller or regulator (113) or the superordinate controller can input a blocking signal to the shut-off safety valve (105) which shuts off the valve.
Aspect 96. The delivery device according to any one of the immediately preceding six aspects, comprising the electric drive motor (25), a controller or regulator (113) for controlling or regulating the drive motor (25), and at least one of the following components:
   a dosing member (106) which is connected to the blower (B) and can be adjusted by means of the controller or regulator (113) between a state of minimum throughput and a state of maximum throughput; and/or
   a sensor (112) for detecting a mass flow or volume flow delivered by the blower (B) and/or a pressure and/or temperature of the medium to be delivered, wherein the sensor (112) is coupled to the controller or regulator (113) in order to be able to input the measured mass flow or volume flow or pressure or temperature, as an actual value for regulating the blower (B) and/or dosing member (106), to the controller or regulator (113); and/or
   a shut-off safety valve (105) for shutting off a fluid connection, preferably a venting conduit (101), which connects a fuel tank (100) to a suction region (107) of a combustion engine (110).
Aspect 97. The delivery device according to any one of the preceding aspects, wherein the delivery device is used as a purge device for a combustion engine (110) and preferably for a drive motor (110) of a motor vehicle.
Aspect 98. The delivery device according to any one of the preceding aspects, wherein the delivery device is used as a purge device for purging a filter (103) for volatile fuel components using purge gas, and the blower (B) is used as a purge gas blower, preferably in a motor vehicle.
Aspect 99. The delivery device according to any one of the immediately preceding two aspects, wherein the delivery device comprises a controller or regulator (113) or is connected to an external controller or regulator (113), and the controller or regulator (113) is configured to operate the blower (B) in accordance with input signals, for example sensor signals and/or control signals of a superordinate engine controller, and thus in accordance with the capacity of a drive motor (110) of the motor vehicle to take on purge gas.

### BRIEF DESCRIPTION OF THE DRAWINGS

Example embodiments of the invention are described below on the basis of figures. Features disclosed by the example embodiments, each individually and in any combination of features, advantageously develop the subject-matter of the claims and aspects as well as the embodiments described above. There is shown:

FIG. 1 a delivery device for purging a filter for volatile fuel components;

FIG. 2 characteristic curves of conventional side channel blowers and peripheral blowers;

FIG. 3 characteristic curves of typical radial blowers;

FIG. 4 a delivery device comprising a side channel blower featuring an electric drive, in a perspective view;

FIG. 5 the delivery device of FIG. 4, in a plan view onto the side channel blower;

FIG. 6 the side channel blower of FIGS. 4 and 5, in a longitudinal section through a delivery channel and an interrupter channel;

FIG. 7 the side channel blower of FIGS. 4 and 5, in the region of the interrupter channel, wherein a uniformly increased sealing gap is formed between the interrupter channel and paddles of an impeller;

FIG. 8 a comparison of the increased sealing gap and the sealing gap of a conventional side channel blower, in the same longitudinal section as FIG. 7;

FIG. 9 a side channel blower in a longitudinal section, wherein a bypass is provided which bypasses the interrupter channel;

FIG. 10 a housing part of the side channel blower of FIG. 9, in a plan view;

FIG. 11 the housing part of FIG. 10, in the same plan view;

FIG. 12 a comparison of delivery-pressure-over-delivery-flow characteristic curves;

FIG. 13 a comparison of current-consumption characteristic curves;

FIG. 14 a peripheral blower comprising a bypass valve, in a schematic representation;

FIG. 15 a side channel blower comprising an integrated bypass valve, in a plan view and a partial section;

FIG. 16 a comparison of delivery-pressure-over-delivery-flow characteristic curves;

FIG. 17 a comparison of current-consumption characteristic curves;

FIG. 18 an impeller comprising paddles exhibiting a rounded axially outer edge;

FIG. 19 a detail of FIG. 18;

FIG. 20 the impeller of FIG. 18, in a plan view onto the radially outer circumference;

FIG. 21 a detail of FIG. 20;

FIG. 22 a plan view onto the radially outer circumference of an impeller comprising paddles which are chamfered on their axially outer edge;

FIG. 23 a detail of FIG. 22;

FIG. 24 a part of the impeller comprising the chamfered paddle edges of FIGS. 22 and 23;

FIG. 25 a paddle comprising a radially outer edge which is convex in a plan view onto a front side of the paddle;

FIG. 26 an impeller in which the paddles exhibit an inclination in their radially outer region;

FIG. 27 a delivery-pressure-over-delivery-flow characteristic curve of a delivery device which is limited in terms of its current consumption; and

FIG. 28 the current-consumption characteristic curve of the delivery device which is limited in this respect.

### DETAILED DESCRIPTION OF THE PREFERRED EMBODIMENTS

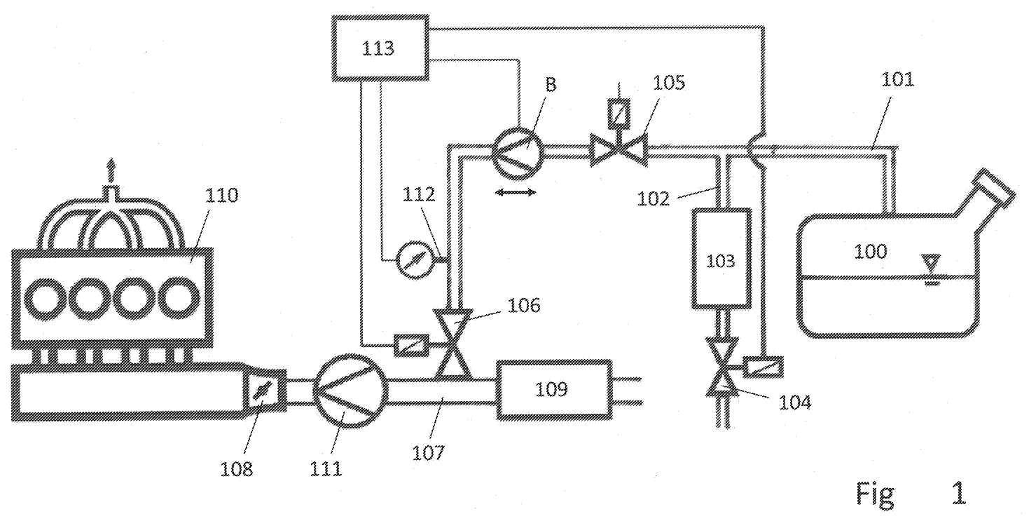

FIG. 1 shows a delivery device for venting a fuel tank 100 and regenerating a filter 103 for volatile fuel components. The delivery device comprises a side channel blower or peripheral blower B for delivering purge gas into the suction region 107 of a combustion engine 110 which can in particular be the drive motor of a motor vehicle, i.e. an internal combustion engine. The combustion engine is typically a spark-ignition engine. The purge gas contains, in a mixture with ambient air, the volatile fuel components previously stored in the filter 103 and released for the purpose of regenerating, and the volatile fuel components from the tank 100. The blower B can be reversed in terms of its delivery direction, in order also be able to perform a tank leakage test using the same blower B.

The blower B is connected to the tank 100 via a venting conduit 101 and to the filter 103 via a regenerating conduit 102 which branches off from the venting conduit 101. The filter 103 can in particular be an activated carbon filter. A shut-off safety valve 105 is arranged in the venting conduit 101, downstream of the junction to the filter 103 and upstream of the blower B in relation to the delivery direction towards the combustion engine 110. When an emergency is detected, for example in the event of a vehicular crash, the shut-off safety valve 105 closes the venting conduit 101 and therefore separates the tank 100 and the filter 103 from the blower B and in particular from the suction region 107 of the combustion engine 110.

The filter 103 is connected to the outer environment via a shut-off valve 104. In purge operations, i.e. when the purge gas is delivered towards the combustion engine 110 and when the combustion engine 110 is switched off, the shut-off valve 104 is open in order to enable pressure equalisation with the atmosphere. The shut-off valve 104 is closed when a leakage test is being performed on the tank 100.

The venting conduit 101 leads from the blower B into the suction region 107. The venting conduit 101 can in particular emerge into the suction region 107, which is typically a suction pipe, upstream of a throttle member 108, which is typically a throttle valve. An air filter 109 for the fresh air suctioned by the combustion engine 110 can be arranged in the suction region 107, upstream of the convergence point for the purge gas. A supercharger 111 can be arranged between the convergence point for the purge gas and the throttle member 108.

A dosing valve 106 is arranged in the venting conduit 101, downstream of the blower B and at or upstream of the convergence point into the suction region 107 in the flow direction towards the combustion engine 110. The dosing valve 106 can in particular be formed as an electric dosing valve and preferably as a pulse-width-modulated dosing valve. The dosing valve 106 can be a switching valve, which can be switched between discrete switched states, or a proportional valve.

The blower B is driven by an electric motor. The delivery device comprises a controller or regulator 113 for controlling or regulating the drive motor of the blower B and dosing valve 106. The controller or regulator 113 can optionally also control the shut-off valve 104 and/or the shut-off safety valve 105. The controller or regulator 113 is configured to control or regulate the electric motor of the blower B in terms of its rotational speed and optionally in terms of its rotational direction. The controller or regulator 113 is also configured to control or regulate the dosing valve 106. It controls or regulates in accordance with the operating state of the combustion engine 110 and/or the loaded state of the filter 103. In advantageous embodiments, the blower B is controlled or regulated at least in terms of its rotational speed in accordance with a control signal which is representative of the respective operating state of the combustion engine 110.

The controller or regulator 113 can be arranged in or on a housing of the blower B. It can however instead also be arranged separately from the blower B and connected to the electric motor by a wire connection or also, as applicable, wirelessly. If the combustion engine 110 is the internal combustion engine of a motor vehicle, the controller or regulator 113 can be connected to a superordinate engine controller or can be an integrated part of said engine controller.

The controller or regulator 113 can be configured to keep the rotational speed of the blower B low, for example in the range of 1,000 to 3,000 rpm, when there is no purge requirement or only a low purge requirement in terms of the loaded state of the filter 103 and/or when the combustion engine 110 is currently in an operating state which is unfavourable for supplying purge gas. The controller or regulator 113 can alternatively or preferably additionally be configured to increase the rotational speed of the blower B and operate the blower B in the upper rotational speed range of for example 15,000 to 25,000 rpm or 15,000 to 20,000 rpm when there is a large purge requirement due to a highly loaded state of the filter 103 and/or when the combustion engine 110 is in an operating state which is suitable for supplying purge gas.

The controller or regulator 113 is advantageously configured to control and/or regulate the supply of purge gas by altering the rotational speed of the blower B, preferably in the upper rotational speed range, when the purge requirement is high and/or in an operating state of the combustion engine 110 which is favourable for supplying purge gas. In order to set the purge gas flow when the purge requirement is low and/or in operating states of the combustion engine 110 which are unfavourable, the controller or regulator 113 can be configured to control or regulate the supply of purge gas up to and including zero delivery by means of the dosing valve 106 while the blower B is operated in the lower rotational speed range, for example in a rotational speed range of 1,000 to 3,000 rpm. The controller or regulator 113 can then be configured to drive the blower B at a constant, low rotational speed of less than 5,000 rpm or less than 3,000 rpm and to control or regulate the supply of purge gas solely by means of the dosing valve 106 when the purge requirement is low and/or in an operating state of the combustion engine 110 which is unfavourable for purging. Additionally or instead, the dosing valve 106 can be fully opened, and the purge gas can be supplied solely by controlling or regulating the rotational speed of the blower B, when the purge requirement is high and/or in an operating state of the combustion engine 110 which is favourable for purging.

Where the rotational speed of the blower B is mentioned, this is understood to mean the rotational speed of an impeller of the blower B. If the blower B comprises several impellers, the above statements regarding the controlling and/or regulating principle apply to the rotational speed of each of the impellers.

The delivery device can comprise a sensor 112 which can in particular be arranged in the venting conduit 101 between the blower B and the suction region 107, preferably between the blower B and the dosing valve 106, in order to measure the mass flow or volume flow or pressure or temperature of the purge gas at said point and to supply said measurement value to the controller or regulator 113. The controller or regulator 113 is embodied as a regulator in such embodiments. It can be connected to a superordinate controller, for example an engine controller, or can be part of said superordinate controller. The controller or regulator 113 can receive a guiding variable as a nominal value and the output signal of the sensor 112 as an actual value from the superordinate controller, in accordance with the operating state and/or load state of the combustion engine 110. When developed into a regulator, the controller or regulator 113 can be configured to regulate the blower B and/or the dosing valve 106 in accordance with the nominal value and the actual value. To this end, it performs a nominal/actual comparison, for example by finding the difference between the nominal value and the actual value, and regulates the blower B and/or the valve 106 using an actuating variable for the blower B, formed as a function of the nominal/actual comparison, and/or an actuating variable for the dosing valve 106, formed as a function of the nominal/actual comparison, in accordance with the previously described dividing regime between the blower B and the dosing valve 106.

The dosing valve 106 can be arranged separately from the blower B, away from the blower B or on a housing of the blower B, for example directly at the outlet, or in the housing of the blower B. The shut-off safety valve 105 can be arranged separately from the blower B, away from the blower B or on the housing of the blower B, for example directly at the inlet, or in the housing of the blower B. The sensor 112 can be arranged separately from the blower B, away from the blower B or on the housing of the blower B, for example directly at the outlet, or in the housing of the blower B.

As mentioned, the blower B is a side channel blower or peripheral blower. Blowers B of this type are broadly comparable to radial blowers, such as are typically used in purge gas delivery devices, in terms of their effectiveness, but have the crucial advantage that their working rotational speed range is far lower than the working rotational speed range of radial blowers, typically around a third of that of radial blowers. They are accordingly superior to radial blowers in their acoustic characteristics, since their imbalance-induced structure-borne noise is significantly lower than that of radial blowers. Due to their lower rotational speed, the kinetic energies stored in the rotating masses of the blower are smaller than in radial blowers. This results in advantageous dynamic characteristics. The power consumption, typically the current consumption, is lower because smaller masses have to be accelerated and decelerated when the rotational speed is changed. The side channel blower or peripheral blower can therefore be accelerated and decelerated more rapidly. This is crucially advantageous for use in motor vehicle manufacturing. Conversely, the “delivery pressure over delivery flow” characteristic curve rises significantly as the delivery flow decreases, and the delivery pressure reaches its highest value at zero delivery, i.e. when the blower outlet is closed. Correspondingly, the power consumption of an electric motor for driving the blower also rises, likewise linearly and in a good approximation, towards zero delivery.

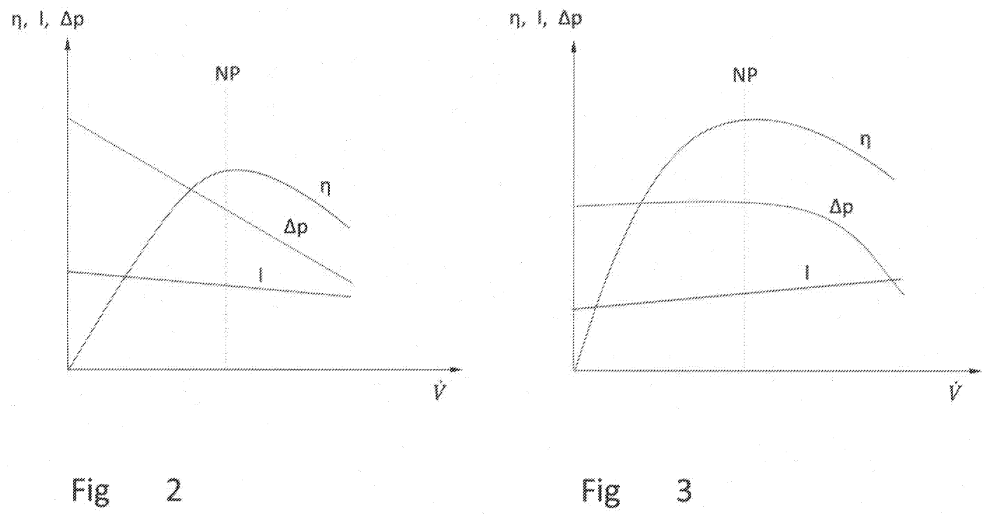

FIGS. 2 and 3 indicate the characteristic curves for the effectiveness η, the delivery pressure Δp and the electric current consumption I over the delivery flow \dot{V} for a side channel blower or peripheral blower B (FIG. 2) and for a radial blower (FIG. 3). NP denotes the nominal point and/or nominal working point for both types of blower. Where “delivery pressure” is mentioned in relation to the delivery characteristic curve, this is the difference in pressure between the inlet and the outlet, i.e. the increase in pressure which the medium to be delivered—in this case, purge gas—experiences due to the blower B.

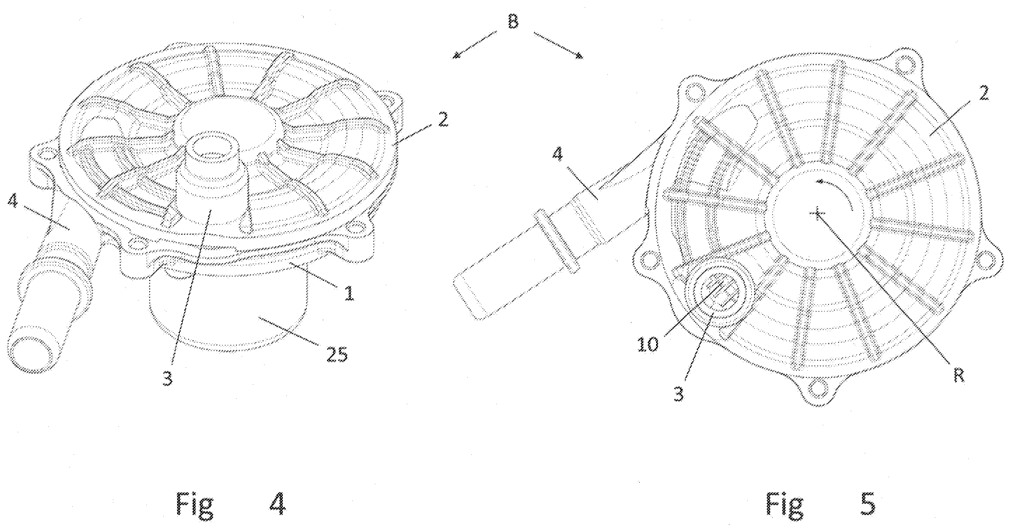

FIG. 4 shows the blower B and an electric drive motor 25 for driving the blower B, in a perspective view. FIG. 5 shows the blower B in a plan view onto the end-facing side facing away from the electric motor 25.

The blower B comprises a housing part 1 and a housing part 2 which together form the housing 1, 2 of the blower B. The housing part 2 serves as a cover for the housing part 1. The blower B comprises an inlet 3 and an outlet 4 for the medium to be delivered by the blower B—in the example embodiment, purge gas. In the housing 1, 2, an impeller 10 which in FIG. 5 can be seen through the inlet 3 is arranged such that it can rotate about a rotational axis R. When the impeller 10 is rotary-driven anti-clockwise, as indicated by a directional arrow, the medium to be delivered flows via the inlet 3 parallel to the rotational axis of the impeller 10, i.e. axially, into a delivery channel which extends in the circumferential direction in the housing 1, 2, while it is expelled via the outlet 4 tangentially with respect to the rotational axis of the impeller 10. Due to the axial inward flow, the blower B of the example embodiment is a side channel blower; if the medium to be delivered flows in radially or tangentially on the radially outer circumference of the impeller 10, it would be a peripheral blower. Within the context of an aspect of the invention, the term “blower” is intended to encompass side channel blowers and peripheral blowers equally.

The electric motor 25 is arranged coaxially with the impeller 10. The shaft of the electric motor 25 can in particular directly form the drive shaft for the impeller 10. The housing part 1 can be elongated in the shape of a socket, and its elongated region can surround the electric motor 25. Alternatively, the electric motor 25 can be arranged in a motor housing of its own, and said motor housing can be fitted on the housing 1, 2 of the blower B.

The electric motor 25 receives its control signals from the controller or regulator 113 (FIG. 1) and is controlled or regulated in terms of its rotational speed and optionally also its rotational direction by the controller or regulator 113.

FIG. 6 shows the blower B in a longitudinal section. The blower B comprises the housing parts 1 and 2, which together form the housing 1, 2 of the blower B, and the impeller 10 which can rotate in the housing 1, 2 about the rotational axis R. A plurality of paddles 13 are arranged on the radially outer circumference of the impeller 10 in a distribution over the circumference, expediently in a uniform distribution over the circumference, and protrude radially outwards over the radially outer circumference of the impeller 10. The radially outer circumference of the impeller 10 comprises a radially protruding circumferential bulge 11 into which the paddles 13, which otherwise protrude freely from the circumference of the impeller 10, protrude slightly. The circumferential bulge 11 serves to fasten the paddles 13 stably on the impeller 10. The paddles 13 can for example be placed or inserted into the circumferential bulge 11 and additionally connected to the impeller 10 in a material fit.

A delivery channel 5 and an interrupter channel 8 are formed in the housing 1, 2, one behind the other in the circumferential direction around the rotational axis R, and the paddles periodically pass, one after the other, through the delivery channel 5 and the interrupter channel 8 when the impeller 10 is rotary-driven. The inlet 3 and the outlet 4 (FIG. 4) emerge into the delivery channel 5. The delivery channel 5 extends at least from the inlet 3 up to at least the outlet 4. The interrupter channel 8 serves to fluidically separate the inlet 3 and the outlet 4 and accordingly surrounds the paddle 13 or each of the paddles 13 situated in the interrupter channel 8, forming a sealing gap 24.

The delivery channel 5 comprises at least one side channel, such as is known from side channel blowers and peripheral blowers. In the example embodiment, the delivery channel 5 comprises a first side channel 6, which extends in the circumferential direction from the inlet 3 up to the outlet 4 along one end-facing side of the paddles 13, and a second side channel 7 which likewise extends from the inlet 3 up to the outlet 4, along the other end-facing side of the paddles 13. In the example embodiment, the two side channels 6 and 7 are also connected via a radial channel which extends from the inlet 3 up to the outlet 4 along the radially outer circumference of the paddles 13.

When the impeller 10 is rotary-driven, the medium to be delivered which is suctioned via the inlet 3 (FIGS. 4 and 5) is swept along in the delivery cells between adjacent paddles 13. Due to centrifugal force, the medium to be delivered flows in the circumferential direction in the delivery cells, radially outwards, against the facing inner wall of the delivery channel 5, where it is deflected axially outwards and flows through the respective side channel 6 and 7 into a delivery cell which is a trailing delivery cell in relation to the rotational movement, such that overall a spiral flow around the paddles 13 is established and the medium to be delivered is expelled through the outlet 4 at an increased pressure. The delivery effect of the blower B is based on the rotational flow and on impulse transmission on the front sides of the paddles 13, i.e. the sides which are front sides in the rotational direction, which combine to result in the spiral flow.

The effective area for impulse transmission, i.e. the effective area A_{P} of the paddle, is marked in FIG. 6 by crosshatching on the paddle 13 situated in the delivery channel 5. The effective area A_{P} of the paddle is the area of the paddle which points orthogonally with respect to the rotational direction or, if the paddle does not exactly extend radially, the proportion of the area of the paddle which points orthogonally with respect to the rotational direction. In the example embodiment, the effective area A_{P} of the paddle is the area of the paddle within the outer edge of the paddle, less the longitudinal sectional area of the circumferential bulge 11. If the paddles 13 protrude at an inclination to the radial onto the rotational axis R, i.e. are for example plainly oblique or roundly curved or inverted, then the effective area A_{P} of the paddle is the area of the paddle projected in or counter to the rotational direction of the impeller 10. In this projection, the points on the front side of the respective paddle 13 are projected on parallel orbits into the same central longitudinal sectional plane. The rotational axis R extends in this central longitudinal sectional plane.

Radially inwards from the paddles 13, the impeller 10 comprises a constriction 12 on each of its two end-facing sides. The respective constriction 12 completely encircles the rotational axis R. The housing parts 1 and 2 each engage the assigned constriction 12 via a projection 1a and 2a which correspondingly encircles the rotational axis R. This engagement improves the seal on the delivery channel 5 and interrupter channel 8 towards the radially inner side, in that the engagement forms a sinuous sealing gap 10a, i.e. a labyrinth seal, on each of the two end-facing sides of the impeller 10. The engagement can also serve to radially and/or axially guide the impeller 10.

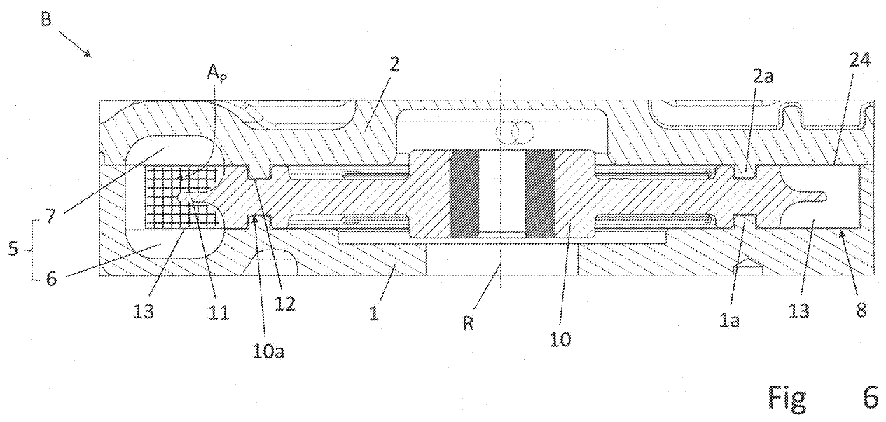

FIGS. 7 and 8 show a first example embodiment of a blower B for which the delivery-pressure-over-delivery-flow characteristic curve is flattened towards zero delivery. Only the radially outer region of the housing 1, 2 and impeller 10 is shown, comprising a modified, i.e. widened interrupter channel 9 and a correspondingly increased sealing gap 20. Aside from widening the interrupter channel 9 and by association increasing the sealing gap 20, the blower B modified in this way corresponds to the blower B of FIGS. 4 to 6.

The paddles 13 each comprise a free outer edge which extends from a left-hand base point 14 of the paddle located on the radially outer circumference of the impeller 10, along a first end-facing side, then along a radially outer circumference and then along the other end-facing side of the paddle 13 up to a right-hand base point 15 of the paddle located on said other end-facing side on the radially outer circumference of the impeller 10. This free outer edge of the paddle which extends from the base point 14, which is the left-hand base point of the paddle in FIG. 7, up to the right-hand base point 15 of the paddle limits the effective area A_{P} of the paddle. The increased sealing gap 20 is limited on the inner side by the outer edge of the paddle and on the outer side by the inner walls of the interrupter channel 9 which face the outer edge of the paddle. Accordingly, the sealing gap 20 comprises a first axial sealing gap 21 which extends along the first end-facing side of the paddle 13, a radial sealing gap 22 which extends along the radially outer circumference of the paddle 13, and a second axial sealing gap 23 which extends along the other end-facing side of the paddle 13. The first axial sealing gap 21, the radial sealing gap 22 and the second axial sealing gap 23 together form the increased sealing gap 20, i.e. they each form sealing gap portions of the overall sealing gap 20.

The increased sealing gap 20 extends radially up to the level of each of the base points 14 and 15 of the paddle and exhibits the area A_{SG} in the longitudinal sectional plane of the effective area A_{P} of the paddle. If the directly adjoining interrupter channel 9 is also then widened radially inwards from the paddles 13 in an overlap with the impeller 10, this wider region does not count towards the sealing gap 20. For the purposes of comparison, only the sealing gap which extends around the paddles 13 from the base point 14 to the base point 15 is adduced as the increased sealing gap 20. Similarly, for the purposes of comparison, only the cross-section of the channel in the longitudinal sectional plane of the effective area A_{P} of the paddle which the paddles 13 pass through is understood to be the free cross-section A_{IC} of the interrupter channel 9.

FIG. 8 shows the widened interrupter channel 9 and accordingly increased sealing gap 20 and, in a dashed line for comparison, an interrupter channel 8 and sealing gap 24 such as may be encountered in conventional side channel blowers and peripheral blowers. The conventional sealing gap 24 is dimensioned such that the downstream end portion of the delivery channel 5 (FIG. 6), into which the outlet 4 (FIG. 4) emerges, is fluidically separated as far as possible from the upstream end portion of the delivery channel 5 into which the inlet 3 emerges. Conversely, the conventional sealing gap 24 is precisely of a size such that the free movement of the impeller 10 is ensured in conditions such as are to be expected during operations.

In the example embodiment, the increased sealing gap 20 is widened along the entire outer edge of the paddle, i.e. continuously from the base point 14 up to the base point 15, axially on the two end-facing sides and radially on the radially outer circumference, as compared to the conventional sealing gap 24. The axial sealing gaps 21 and 23 each exhibit an axial gap width Wₐ measured in the axial direction. The radial sealing gap 22 exhibits a radial gap width Wᵣ measured in the radial direction. The two axial sealing gaps 21 and 23 can be equal, but can in principle also be unequal. In the example embodiment shown, the radial gap width Wᵣ is larger than the axial gap width Wₐ. Alternatively, however, the gap widths Wₐ and Wᵣ can also be equal, or the axial gap width Wₐ of the axial sealing gap 21 and/or the axial gap width Wₐ of the other axial sealing gap 23 can be larger than the radial gap width Wᵣ.

The axial gap width Wₐ of the first sealing gap 21 and/or the axial gap width Wₐ of the second sealing gap 23 can (each) be invariable, i.e. constant, over the entire radial length of the respective sealing gap 21 and 23. Instead or expediently in addition, the radial gap width Wᵣ can be constant over the entire axial length of the radial sealing gap 22. Although constant gap widths Wₐ and Wᵣ are preferred, not least because they are simple to produce, one or both of the axial gap widths Wₐ can vary over the radial length of the respective sealing gap 21 and 23. Instead or additionally, the radial gap width Wᵣ can vary. If one or more of the gap widths Wₐ and Wᵣ varies/vary along the respective sealing gap 21 to 23, the respective axial gap width Wₐ increases only monotonically in the radial direction and preferably over at least the majority of the radial length, in order to obtain a sealing gap 21 and/or 23 which is uniformly broadened as viewed over its length, despite said variation, and in particular to avoid local constrictions. If the radial gap width Wᵣ varies in the axial direction, this variation occurs uniformly over the entire axial length of the sealing gap 22, wherein the sealing gap 22 can simply extend convexly in a uniform arc, i.e. can bulge outwards, or can simply extend concavely in a uniform arc, i.e. can bulge inwards.

In expedient embodiments, such as the example embodiment, a widened interrupter channel 9 is provided in order to realise the increased sealing gap 20. At their axially outer base points 14 and 15, the paddles 13 each exhibit the axial width of the annular region of the impeller 10 which borders the paddles 13 radially inwards. The opposing inner walls of the interrupter channel 9 which face each other axially across the respective paddle 13 recede axially via a collar formed at the level of each of the base points 14 and 15 of the paddle, in order to obtain the respective axial gap width Wₐ. In alternative embodiments, the paddles 13 can be embodied to be narrower along one end-facing side and/or the other end-facing side, such that the inner wall of the interrupter channel 9 which faces the axially recessed axial edge of the paddle can smoothly proceed radially outwards past the respective base point 14 or 15 of the paddle. Providing the uniformly increased sealing gap 20 by axially widening the interrupter channel 9 is however preferred.

The axial sealing gap 21 and/or the axial sealing gap 23 exhibits or each exhibit an axial gap width Wₐ throughout the respective sealing gap 21 and 23 which is larger than, and in advantageous embodiments at least twice as large as, the axial gap width of the axial sealing gap 10a, adjoining on the radially inner side, between the impeller 10 and the axially facing inner wall region of the interrupter channel 9. The radial gap width Wᵣ can be larger, throughout its axial length, than the axial gap width of the radial sealing gap 10a and preferably at least twice as large as the axial gap width of the sealing gap 10a. The sealing gap 10a expediently exhibits the same gap width throughout its entire profile. The gap width is also preferably invariable in the region of the engagement between the constriction 12 and the projections 1a and 2a, aside from any deviations in the corner regions and edge regions.

The leakage which is specifically set via the interrupter channel 9 by means of increasing the sealing gap 20 can in particular be characterised by the ratio A_{SG}/A_{P} between the area of the sealing gap and the effective area of the paddle. In advantageous embodiments, it holds that A_{SG}/A_{P}≥0.06 or A_{SG}/A_{P}≥0.07. In relation to favourable degrees of effectiveness in the full-load range, i.e. at delivery flows equal to or greater than the delivery flow at the nominal delivery point or nominal point, it is advantageous if A_{SG}/A_{P}≤0.25 or A_{SG}/A_{P}≤0.20. Alternatively or additionally, it holds for the ratio between the area A_{SG} of the sealing gap and the cross-section A_{IC} of the channel that A_{SG}/A_{IC}≥0.05 or preferably A_{SG}/A_{IC}≥0.06. With regard to the degree of effectiveness, it is favourable if A_{SG}/A_{IC}≤0.20 or A_{SG}/A_{IC}≤0.15 or A_{SG}/A_{IC}≤0.13.

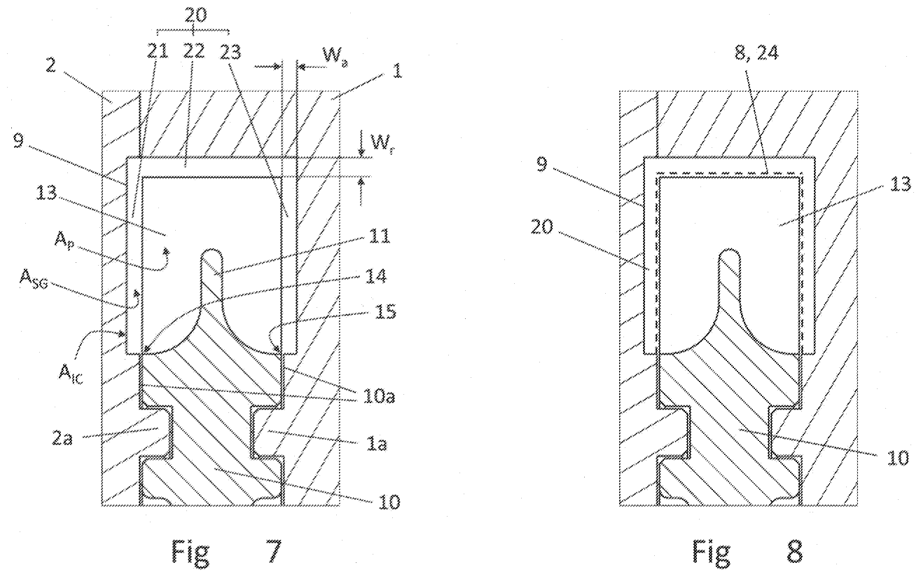

FIG. 9 shows a blower B of a second example embodiment, in a longitudinal section in which the rotational axis R extends. The electric motor 25, which is arranged in a motor housing 26, is also shown. The electric motor 25 comprises a rotor 27 and a stator 28 which are shown in FIG. 9 as a single block. The electric motor 25 can for example be embodied as a brushless DC or asynchronous motor, expediently comprising an integrated rotational angle transmitter. The motor housing 26 is fitted on the housing part 1 of the blower housing 1, 2. The impeller 10 is placed directly on the motor shaft and non-rotationally connected to the motor shaft. A shaft seal 29 seals off the region connecting the impeller 10 and the motor shaft.

In order to flatten the delivery-pressure-over-delivery-flow characteristic curve, a bypass is provided in the second example embodiment, through which the medium to be delivered can flow back from a region of high pressure into a region of low pressure by bypassing the interrupter channel, for example a conventional interrupter channel 8 (FIG. 6) or a widened interrupter channel 9 (FIGS. 7 and 8).

The bypass can be provided solely within the housing 1, 2 of the blower B or can extend successively through the blower housing 1, 2 and the motor housing 26, as indicated in FIG. 9 by directional arrows. FIG. 9 also indicates how the bypass can bifurcate, such that a first bypass branch extends in the blower housing 1, 2, and a bypass branch which branches off from the first bypass branch extends through the motor housing 26. A bypass branch which is realised in the blower housing 1, 2 can in particular extend on the end-facing side of the impeller 10 which faces the electric motor 25. This first variant is realised in the second example embodiment. In an alternative second variant, a comparable bypass can extend on the end-facing side of the impeller 10 which faces away from the electric motor 25. In a third variant, one bypass can extend as in the second example embodiment and another bypass can extend on the end-facing side of the impeller 10 which faces away from the electric motor 25, each within the housing 1, 2. In all three variants, an additional bypass or bypass branch can optionally lead through the motor housing 26.

FIG. 10 shows the housing part 1 in an axial plan view onto the inner side of the housing part 1. The bypass as a whole is referred to as the bypass 30. The bypass branch which extends in the blower housing 1, 2 on the end-facing side of the impeller 10 which faces the electric motor 25 comprises bypass portions 32, 33 and 34 which extend in the housing part 1, axially facing the impeller 10.

The bypass 30 comprises the upstream bypass portion 32 which branches off from the delivery channel 5 at a divergence opening 31 which emerges in the high-pressure region of the delivery channel 5. Of the delivery channel 5, the side channel 6 formed in the housing part 1 can be seen in the plan view of FIG. 10. The divergence opening 31 is arranged in an end region of the delivery channel 5—in this case, the side channel 6—near the outlet 4. The bypass 30 also comprises the central bypass portion 33 into which the bypass portion 32 emerges at its downstream end. The downstream bypass portion 34 adjoins the central bypass portion 33 in the flow direction from the high-pressure region to the low-pressure region and emerges at its downstream end into the low-pressure region of the delivery channel 5—in this case, the side channel 6—via a convergence opening 35. Advantageously, the bypass portion 34 emerges into an end portion of the delivery channel 5 and/or side channel 6 which comprises the inlet 3.

The bypass portions 32 and 34 are cost-effectively, in terms of production, embodied as continuously straight channel portions which are axially open towards the impeller 10. The bypass portions 32 and 34 lead through the projection 1a which, aside from the bypass portions 32 and 34, serves to improve the seal on the delivery channel 5 towards the radially inner side along the profile of the projection 1 a.

As already mentioned, a second bypass branch which leads through the motor housing 26 is provided in the second example embodiment. The second bypass branch comprises an upstream bypass portion 36 and a downstream bypass portion 38 which each emerge in the central bypass portion 33, whence they lead through the housing part 1 and establish a connection to the interior space of the motor housing 26. The points at which the bypass passages 36 and 38 emerge can be seen in FIG. 10. In the motor housing 26, the bypass 30 which is extended in this way can surround the electric motor 25 over a large area in a bypass portion 37, as shown by way of example in FIG. 9, such that the medium to be delivered can cool the electric motor 25, i.e. the rotor 27 and/or the stator 28 of the electric motor 25, over a correspondingly large area as it flows through the bypass branch 36, 37 and 38.

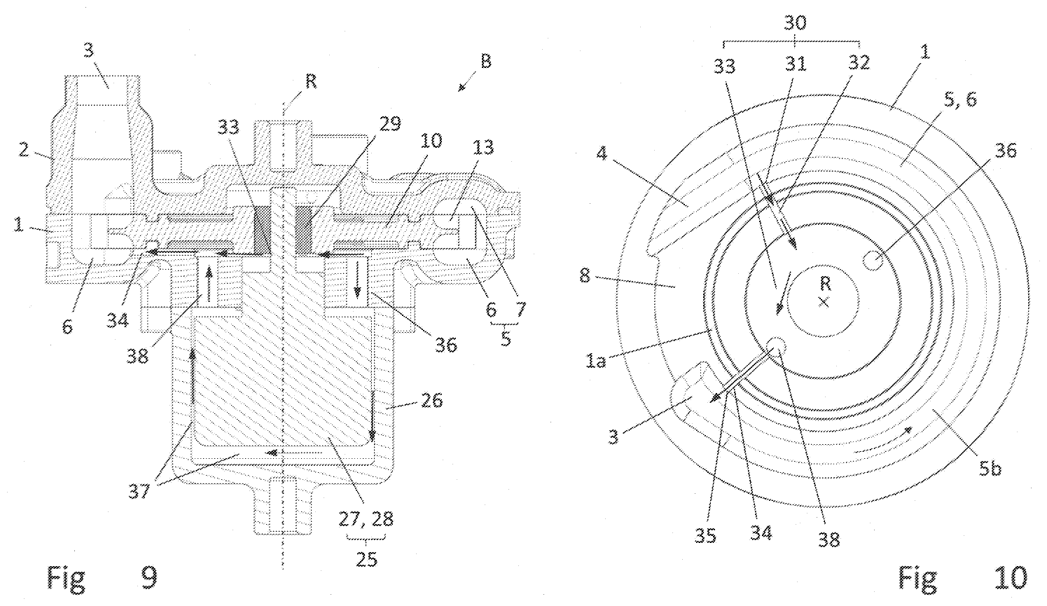

FIG. 11 shows the inner side of the housing part 1 in the same plan view as FIG. 10. Angular extents α, β and γ are indicated, which serve to characterise an advantageous arrangement of the divergence opening 31 and convergence opening 35. Proceeding from the interrupter channel 8 and progressing in the rotational direction (anti-clockwise) in the delivery channel 5, the angular extents α, β and γ mark an upstream delivery portion 5a in which the convergence opening 35 emerges, an intermediate delivery portion 5b, and a downstream delivery portion 5c which extends up to the interrupter channel 8 and in which the divergence opening 31 branches off. The intermediate delivery portion 5b thus extends in the rotational direction up to a point in front of the divergence opening 31 and counter to the rotational direction up to a point in front of the convergence opening 35, i.e. at most up to the divergence opening 31 in the rotational direction and at most up to the convergence opening 35 counter to the rotational direction, and has the angular extent β. The upstream delivery portion 5a borders the interrupter channel 8 and extends in the rotational direction and delivery direction from the interrupter channel 8 up to the intermediate delivery portion 5b and at least completely over the convergence opening 35. The delivery portion 5a has the angular extent α. The downstream delivery portion 5c extends counter to the rotational direction and delivery direction from the interrupter channel 8 up to the intermediate delivery portion 5b and at least completely over the divergence opening 31 and has the angular extent γ.

The bypass 30 (FIGS. 9 and 10) can comprise one or more other bypass portions, each comprising another divergence opening and/or another convergence opening. If two or more divergence openings branch off from the delivery channel 5 in the high-pressure region of the delivery channel 5, then the downstream delivery portion 5c extends over all of these divergence openings. If the extended bypass comprises the convergence opening 35 and one or more other convergence openings which emerge in the low-pressure region of the delivery channel 5, then the upstream delivery portion 5a extends over all of these convergence openings.

In advantageous embodiments, the upstream delivery portion 5a has an angular extent α of at most 60° or at most 45°. The angular extent γ of the downstream delivery portion 5c preferably measures at most 120° or at most 90° or at most 70°. The intermediate delivery portion 5b, in which neither a divergence opening nor a convergence opening for bypassing the interrupter channel 8 emerges, extends over an angle β of advantageously at least 45° or at least 90°. In preferred embodiments, the angular extent β measures at least 120° or at least 180°. The angular extents α, β and γ can in particular be chosen such that α<45°, β>180° and γ<70°. While this is a preferred combination for the angular extents α, β and γ, the relationships previously mentioned can however in principle also be realised in any other combination as desired. With regard to a good degree of effectiveness, however, it is advantageous if it at least holds that β>180°.

In advantageous embodiments, the sum α+β+γ of the angular extents, which corresponds to the angular extent of the delivery channel 5 as a whole, is greater than 270° and preferably greater than 300°.

It is favourable for establishing the spiral flow if the medium to be delivered which is guided back through the bypass 30 is not introduced in the form of a concentrated tangential jet but rather radially or at an angle of at least 45° to the tangential direction. In the second example embodiment, the medium to be delivered which is guided back is channelled back into the delivery channel 5 radially or almost radially through the convergence opening 35, as can be seen in FIGS. 10 and 11.

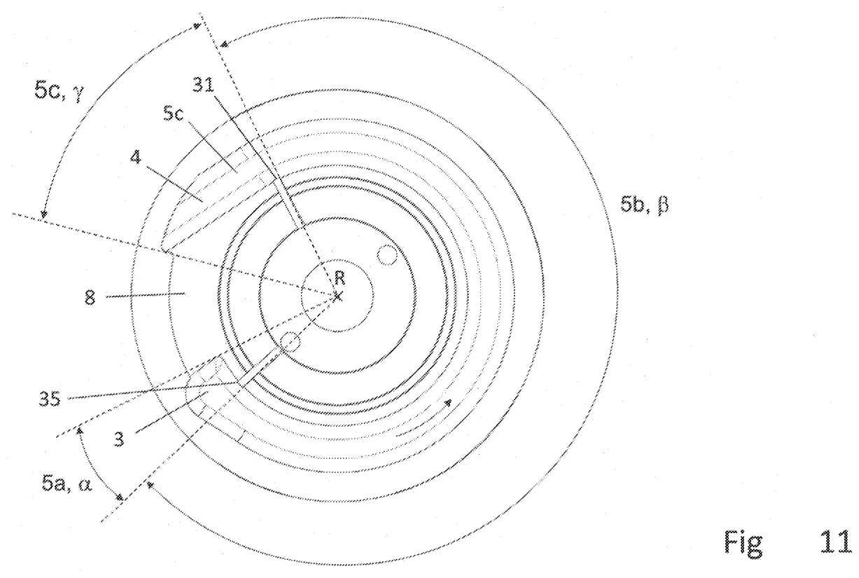

FIGS. 12 and 13 schematically show the delivery-pressure-over-delivery-flow characteristic curve “Δp over \dot{V}” and the characteristic curve for the current consumption “I over \dot{V}”. The corresponding characteristic curve of conventional side channel blowers and peripheral blowers is indicated in each of the two diagrams as a dashed line for comparison. The characteristic curves for a blower B in accordance with an aspect of the invention are shown in a continuous line, wherein the characteristic curves apply both to setting a specific leakage by increasing the sealing gap (first example embodiment) and to setting a specific leakage by providing a bypass (second example embodiment). As can be seen in FIG. 12, the delivery pressure and/or increase in delivery pressure Δp drops in the full-load range from the nominal point NP in the direction of increasing delivery flow \dot{V} at a lower pitch than in conventional comparative blowers and has a significantly flattened profile over the overload range, starting at the nominal point NP and in the direction of minimum delivery flow. A certain loss of delivery pressure at the nominal point NP is negligible. The relationships are similar in the characteristic curve for the current consumption I.

The two measures for specifically setting a leakage, i.e. by means of an increased sealing gap on the one hand and by means of a bypass on the other, can be realised separately from each other or also in combination. When realised in combination, the sealing gap can be broadened to a lesser extent and/or the bypass can be realised with a larger overall flow resistance and/or the angular distance between the divergence opening and the convergence opening can be reduced, such that the two measures in combination generate the desired flattening of the delivery-pressure-over-delivery-flow characteristic curve. In simple and not least for this reason preferred embodiments, however, only one of the two measures is realised.

FIG. 14 schematically shows a blower B of a third example embodiment. The blower B comprises an inlet 3 which emerges on the radially outer circumference of the delivery channel 5. The blower B is therefore a peripheral blower. In the third example embodiment, the “delivery pressure over delivery flow” characteristic curve is flattened by means of a bypass 40a which, like the bypass 30 of the second example embodiment above, bypasses the interrupter channel 8 (FIG. 6) or the widened interrupter channel 9 of the first example embodiment (FIGS. 7 and 8). Unlike the second example embodiment, a bypass valve 43 is arranged in the bypass 40a.

The bypass 40a comprises an upstream bypass portion 42, a downstream bypass portion 44 and the bypass valve 43 which connects the bypass portions 42 and 44 to each other when the bypass valve 43 assumes an opened valve state. In expedient embodiments, the bypass valve 43 can assume a closed state in which it separates the bypass portions 42 and 44 from each other and thus blocks the bypass 40a. The bypass valve 43 can in principle be adjusted between a state of minimum throughput and a state of maximum throughput continuously or discontinuously in one or more increments, preferably in this case abruptly between minimum and maximum throughput. The state of minimum throughput can in particular be a closed state, but can in principle also be a state in which the bypass valve 43 permits a small throughput, i.e. a small leakage flow.

The bypass 40a can connect the outlet 4 to the inlet 3, in that the divergence opening 41 emerges in the outlet 4, the bypass 40a accordingly branches off from the outlet 4, and the convergence opening 45 emerges in the inlet 3. In the example embodiment, the divergence opening 41 emerges in an outlet support which protrudes from the housing of the blower B, i.e. the bypass 40a branches off in the region of the outlet support, and the convergence opening 45 emerges in a convergence support which protrudes from the housing of the blower B. The convergence support and the outlet support form part of the housing of the blower B. The bypass 40a is advantageously formed while still within or on the housing of the blower B, such that the bypass 40a does not have to be fitted at the point of installation in addition to the blower B, but can rather be fitted together with the blower B as a unit.

The bypass valve 43 comprises a valve element 46, for example a valve piston, and a valve spring 47 which acts on the valve element 46 towards the position of minimum throughput. A control conduit 48 branches off on the high-pressure side of the blower B, via which medium to be delivered is guided from the high-pressure side of the blower B to the valve element 46, in order to apply a pressure of the high-pressure side of the blower B to the valve element 46, counter to the spring force of the valve spring 47. The control conduit 48 can for example branch off in the high-pressure region of the delivery channel 5 or in a portion of the outlet 4 which directly adjoins the delivery channel 5. The control conduit 48 can instead also branch off from the outlet support at the outlet 4 or, as in the example embodiment, branch off from the upstream bypass portion 42. The high-pressure side of the blower B extends via the outlet 4 from a downstream portion of the delivery channel 5 up to a consumer to which the medium to be delivered is supplied by means of the blower, for example up to the suction region 107 of the arrangement in FIG. 1, or up to a closing and/or dosing member, for example the dosing valve 106 (FIG. 1), which optionally succeeds the blower B downstream. The low-pressure side of the blower B comprises an upstream delivery portion of the delivery channel 5 and extends upstream from the latter via the inlet 3. The differential pressure between the pressure of the medium to be delivered which is on the high-pressure side and that on the low-pressure side of the blower B thus acts on the valve element 46 in all the variants.

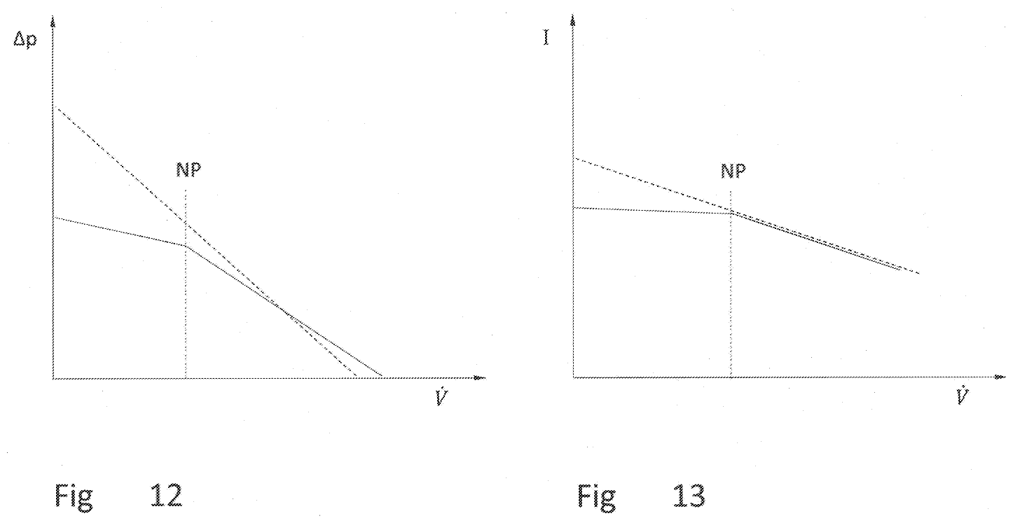

FIG. 15 shows a blower B exhibiting a specific leakage according to a fourth example embodiment. The housing part 1 of the blower B is shown in an axial view onto the inner end-facing side of the housing part 1. The side channel 6 of the delivery channel 5 which is thus exposed can be seen.

Similar to the third example embodiment, the specific leakage is established in the fourth example embodiment by a bypass 40b which is exposed in a partial section of the housing part 1. Unlike the bypass 40a of the third example embodiment, the bypass 40b branches off from the outlet 4 at a divergence opening 41 in a portion of the outlet 4 which extends between the delivery channel 5 and an outlet support which protrudes from the housing part 1. In the example embodiment, the divergence opening 41 radially lies directly above the interrupter channel 8.

The bypass 40b emerges at a convergence opening 45 in an upstream delivery portion of the delivery channel 5 which borders the interrupter channel 8. The statements made with respect to the convergence opening 35 of the second example embodiment (FIGS. 9 to 11) advantageously apply in relation to the arrangement of the convergence opening 45. The divergence opening 41 could also in principle even emerge in a downstream delivery portion of the delivery channel 5, wherein the statements made with respect to the downstream delivery portion 5c of the second example embodiment apply with regard to the downstream delivery portion in such a modification.

The bypass 40b extends from the divergence opening 41 up to the convergence opening 45, radially above the interrupter channel 8 or axially alongside the interrupter channel 8, and can in particular extend at a narrow radial distance along the outer circumference of the interrupter channel 8, as in the example embodiment. The bypass 40b can be closed by the other housing part 2 (FIG. 3) or can advantageously be arranged completely within the housing part 1, as in the example embodiment. The housing of the blower B or just the housing part 1 can be radially widened locally, forming the bypass 40b in the circumferential region from the divergence opening 41 up to the convergence opening 45.

Like the bypass 40a of the third example embodiment, the bypass 40b comprises an upstream bypass portion 42, which branches off from the outlet 4 at its divergence opening 41, and a downstream bypass portion which emerges at its convergence opening 45 in the delivery channel 5. A bypass valve 43 is arranged between the divergence opening 41 and the convergence opening 45.

The bypass valve 43 comprises a valve element 46 which can be moved back and forth between a position of minimum throughput and a position of maximum throughput. In the position of minimum throughput, the bypass valve 43 can permit a certain small leakage flow or advantageously separate the divergence opening 41 from the convergence opening 45 and thus interrupt the bypass 40b. The bypass valve 43 also comprises a valve spring 47 which applies a spring force to the valve element 46 towards the position of minimum throughput. A differential pressure which prevails between the divergence opening 41 and the convergence opening 45 acts counter to the valve spring 47.

The bypass valve 43 of the fourth example embodiment comprises a spring space 49 in which the valve spring 47 is arranged. The spring space 49 is connected to the convergence opening 45 via the downstream bypass portion and is thus relieved of pressure.

The bypass valve 43 is embodied as a reflux valve in the fourth example embodiment, but can in principle also be formed as a valve comprising for example a valve slider. The valve spring 47 pushes the valve element 46 into a valve seating 46a. Each of the spring force and the opposing pressure force of the medium to be delivered points through the valve seating 46a. If the valve element 46 moves towards the position of maximum throughput, a leakage flow of the medium to be delivered flows into the bypass portion 42 via the divergence opening 41, through the valve seating 46a and past the valve element 46, into the downstream bypass portion and finally through the latter's convergence opening 45 into the delivery channel 5.

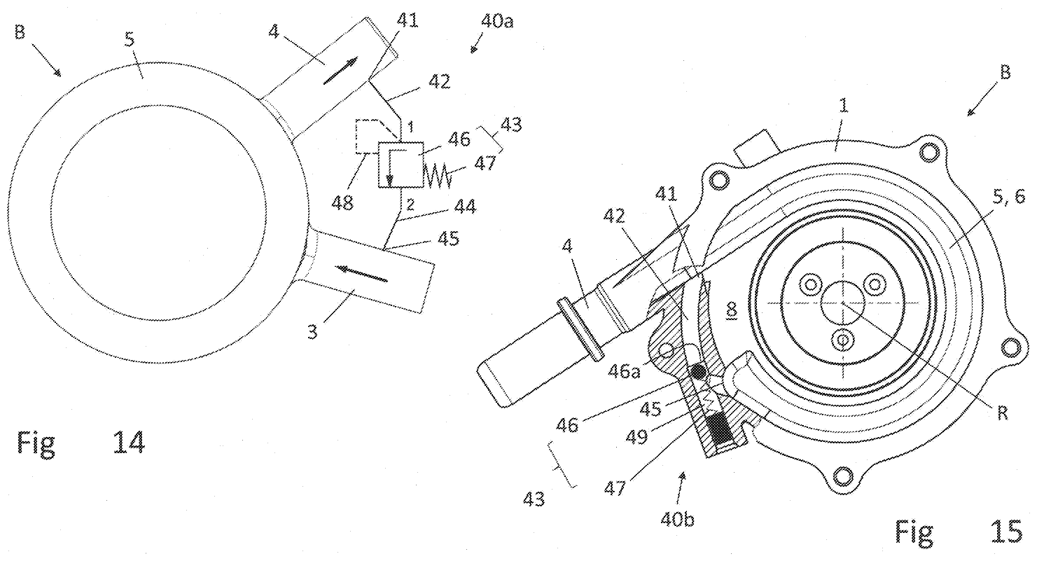

FIGS. 16 and 17 schematically show the delivery-pressure-over-delivery-flow characteristic curve of a blower B comprising a bypass valve 43 (third example embodiment and fourth example embodiment) and the characteristic curve for the current consumption I, each in a comparison with the corresponding characteristic curve of a conventional side channel blower or peripheral blower. The characteristic curve of the blower B in accordance with an aspect of the invention is shown in a continuous line, and the characteristic curve of the conventional blower is shown in a dashed line, in each case. It can be seen that the “delivery pressure over delivery flow” characteristic curve and accordingly also the “current consumption over delivery flow” characteristic curve of the blower B in accordance with an aspect of the invention can correspond, in the full-load range, to the characteristic curve of a comparative blower which is identical aside from the bypass valve 43, namely if the bypass valve 43 interrupts the bypass 40a or 40b in its state of minimum throughput, i.e. if the state of minimum throughput is a closed state.

In the third example embodiment and fourth example embodiment, the leakage flow can be set very exactly by means of the bypass valve 43. The respective bypass valve 43 is configured such that the valve element 46 moves from the position of minimum throughput towards the position of maximum throughput only and always when a differential pressure between the pressure at the divergence opening 41 and the pressure at the convergence opening 45, which is predetermined by means of the valve spring 47, is exceeded. The respective bypass valve 43 can in particular be configured such that this threshold pressure corresponds to at least 80% or at least 90% of the nominal delivery pressure of the blower B. The nominal delivery pressure is the delivery pressure at the nominal delivery point NP of the blower B. If the configuration is such that the threshold pressure is greater than the nominal delivery pressure of the blower B, then the threshold pressure measures at most 120% or at most 110% of the nominal delivery pressure in advantageous embodiments. Configuring the bypass valve 43 such that the threshold pressure corresponds to the nominal delivery pressure of the blower B is particularly expedient.

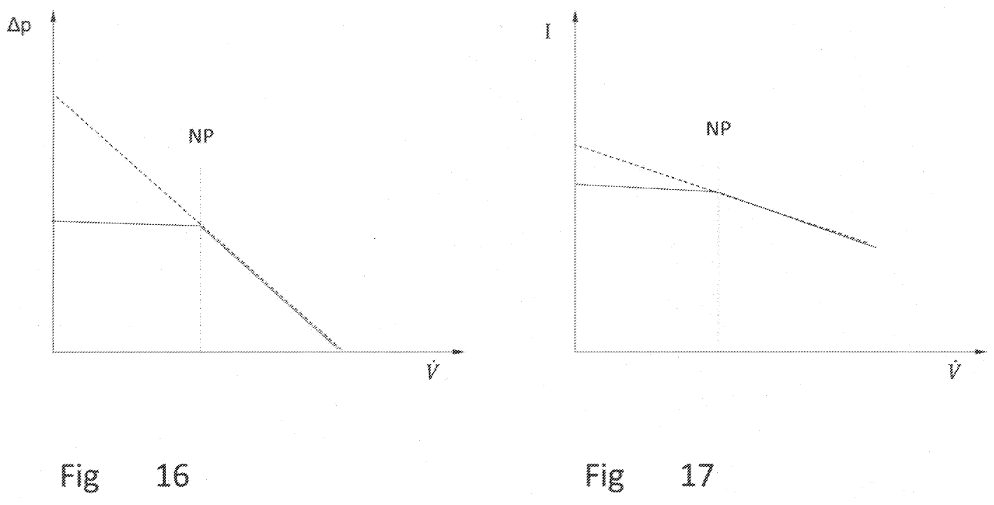

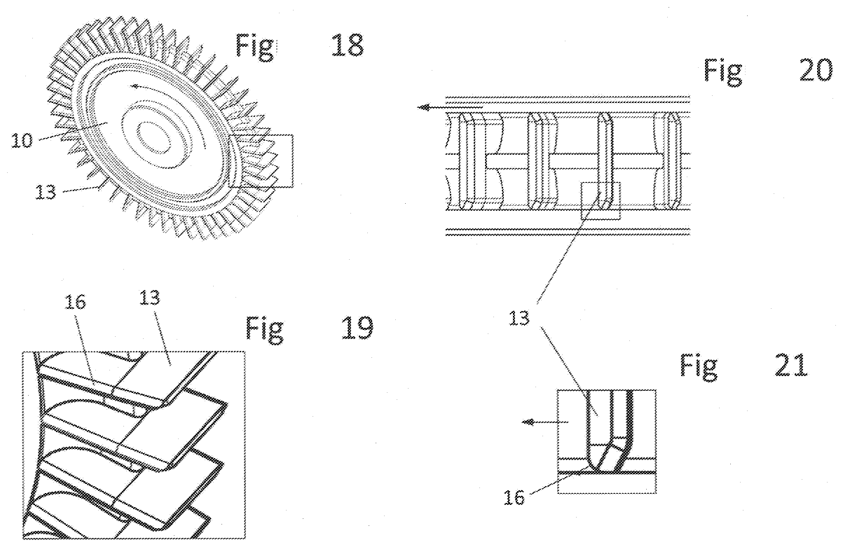

FIG. 18 shows an impeller 10 comprising paddles 13 which comprise a rounded profile 16 on both axially outer edges of the respective paddle 13. FIG. 19 shows a detail of FIG. 18 in an enlarged representation. FIG. 20 is a plan view onto the radially outer circumference of the impeller 10 and the radially outer edge of the paddles 13. FIG. 21 is an axially outer region of the paddle in the same plan view as in FIG. 20 in an enlarged representation, such that the rounded profile 16 can more clearly be seen. The rounded profile 16 points in the rotational direction indicated by a directional arrow, i.e. the front sides of each of the paddles 13 are rounded on both axially outer edges of the paddle. In modifications, the paddles 13 can also comprise the rounded profile 16 along only one of their axially outer edges. The front sides of each of the paddles 13 can optionally be rounded on the radially outer edge of the paddle. A rounded profile 16 on the radially outer edge of the paddle can be provided instead of or in addition to the rounded profile 16 on one or both of the axially outer edges of the paddle.

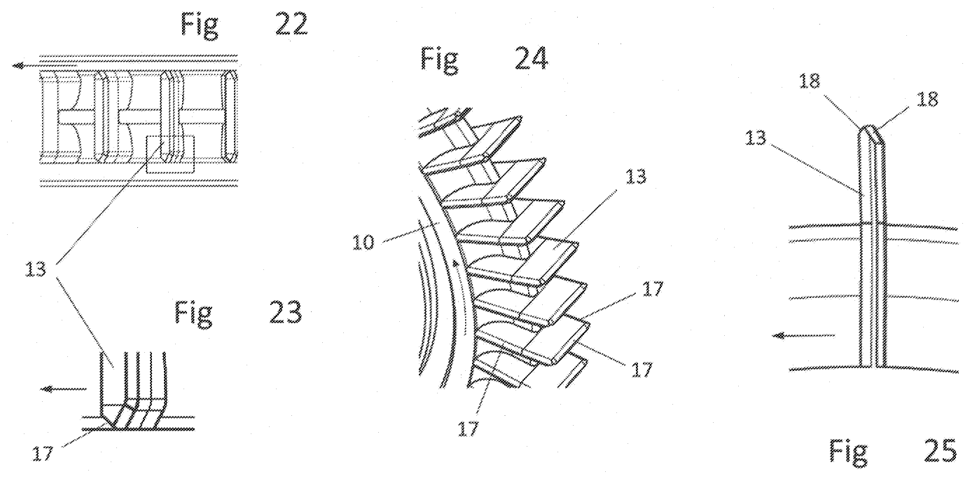

FIGS. 22 to 24 show an impeller 10 comprising paddles 13 which comprise a chamfer 17, i.e. an oblique profile, instead of the rounded profile 16 (FIGS. 18 to 21) on the front sides of both their axially outer edges. In one modification, the paddles 13 can also be chamfered on the front sides of only one of their two axially outer edges. In another modification, a chamfer 17 can be provided additionally or only on the front side of the radially outer edge of the respective paddle 13. The chamfer 17 can point at an angle of 10° to 80° to an axial which is parallel to the rotational axis R.

The paddles can thus comprise the rounded profile 16 over their entire outer edge or only in one or more portions of their edge or can instead comprise the chamfer 17 over their entire outer edge or only in one or more portions of their edge. In modifications, the paddles 13 can comprise the rounded profile 16 in one or more portions of their edge and the chamfer 17 in one or more other portions of their edge, as viewed over their entire outer edge.

The paddles 13 can comprise a rounded profile 16 and/or a chamfer 17 on their front sides only. Alternatively, the paddles 13 can also be convexly rounded or chamfered on their outer edge. A convex chamfer 17 can in particular be trapezium-shaped or conically tapered as viewed in the radial plan view of FIGS. 20 and 22.

Due to the rounded profile 16 and the chamfer 17 of the outer edge of the paddle, the area of the sealing gap of the paddles 13 which is provided in the circumferential direction in the interrupter channel is reduced. This measure also reduces the energy transmission in the overload range, i.e. when there is significant throttling on the pressure side, and thus flattens the delivery-pressure-over-delivery-flow characteristic curve.

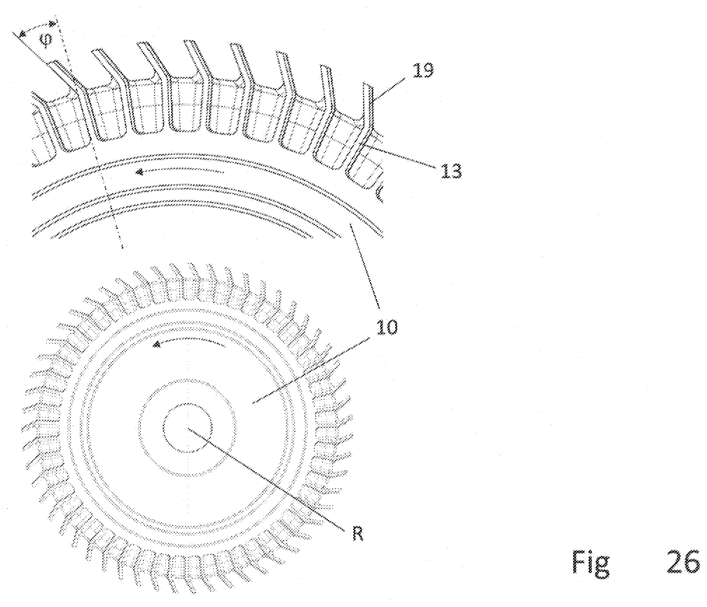

FIG. 25 shows a paddle 13 comprising a radially outer edge 18 which is convex in a plan view onto the front side of the paddle 13. The convex edge 18 of the paddle can be conical or trapezium-shaped or alternatively can also roundly bulge radially outwards.

This measure also establishes a specific leakage in the interrupter channel via the circumferential extent of the interrupter channel.

FIG. 26 shows an impeller 10 comprising paddles 13 which exhibit an inclination ϕ to a radial which extends through the rotational axis R and the respective base point of the paddle. In the example embodiment, the paddles 13 each comprise a radially inner region and a radially outer region 19 which inverts away from the inner region. The inner region of each of the paddles points radially with respect to the rotational axis R of the impeller 10, while the radially outer region 19 of the paddle inverts away from the radially inner region of the paddle in the forward direction. The inner region of the paddle and the outer region 19 of the paddle are each straight in the axial view.

In modifications, the paddles 13 can also be inclined in the forward direction, i.e. in the rotational direction, over their entire radial extent. In another modification, they can invert more than once as viewed over their radial height or can be roundly inclined continuously or only in a radially outer region of the paddle. Alternatively, the paddles 13 can be inclined counter to the rotational direction over their entire radial extent or only in portions. It is however preferred that they be inclined in the forward direction. If, as is preferred, the rotational direction of the blower can be reversed, then the rotational direction is understood to be the rotational direction in which the impeller is predominantly driven and/or for which the blower is primarily configured.

In the example embodiments described above, the “delivery pressure over delivery flow” characteristic curve is flattened by geometrically altering the blower and/or by means of a bypass valve. Alternatively or additionally, it can also be flattened by limiting the power consumption, in particular the current consumption, of the electric motor 25 (FIG. 3).

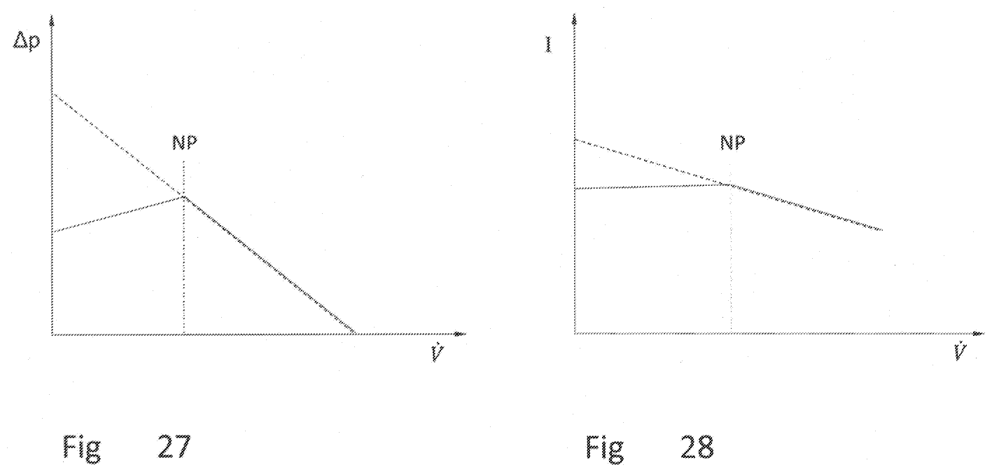

FIGS. 27 and 28 respectively show, in a continuous line, the “delivery pressure over delivery flow” characteristic curve and the “current consumption over delivery flow” characteristic curve of a delivery device (blower B and motor) comprising an electric motor 25 which is limited in terms of its current consumption, in a comparison with a conventional side channel blower or peripheral blower which is identical aside from the limiting. The characteristic curves of the comparative blower are shown in a dashed line. The “delivery pressure over delivery flow” characteristic curve can in practice be set as desired by means of limiting the power consumption, advantageously the current consumption I. FIG. 27 shows an example of an instable profile, i.e. the “delivery pressure over delivery flow” characteristic curve drops in the overload range from the nominal delivery pressure at the nominal point NP towards zero delivery. The profile of the current consumption I, as a guiding variable, is shown in FIG. 28.

The measures in accordance with an aspect of the invention can each be realised individually in a blower B. It is however also possible to employ two or more of the measures, which have been individually disclosed merely by way of example, in combination in the same blower, in order to obtain the flattened and preferably inverting delivery-pressure-over-delivery-flow characteristic curve. Within the meaning of an aspect of the invention, the description of a “flattened characteristic curve” also encompasses a falling, i.e. instable characteristic curve. The one or more measures in combination can be advantageously embodied such that the delivery pressure, i.e. the differential pressure between the inlet 3 and the outlet 4, for example the differential pressure directly across the interrupter channel 8 or 9, is at most 20% or at most 10% above the nominal delivery pressure.

### REFERENCE SIGNS

1 housing part
1 a projection
2 housing part, cover
2a projection
3 inlet
4 outlet
5 delivery channel
5a delivery portion
5b intermediate delivery portion
5c delivery portion
6 side channel
7 side channel
8 interrupter channel, conventional
9 widened interrupter channel
10 impeller
10a sealing gap
11 circumferential bulge
12 constriction
13 paddle
14 base point of the paddle
15 base point of the paddle
16 axial edge of the paddle, rounded
17 axial edge of the paddle, chamfered
18 radial edge of the paddle
19 inclination of the paddle
20 increased sealing gap
21 axial sealing gap
22 radial sealing gap
23 axial sealing gap
24 sealing gap, conventional
25 electric motor
26 motor housing
27 rotor
28 stator
29 shaft seal
30 bypass
31 divergence opening
32 bypass portion
33 bypass portion
34 bypass portion
35 convergence opening
36 bypass portion
37 bypass portion
38 bypass portion
39 -
40a bypass
40b bypass
41 divergence opening
42 bypass portion
43 bypass valve
44 bypass portion
45 convergence opening
46 valve element
46a valve seating
47 valve spring
48 control conduit
49 spring space
50 -
. . . -
100 tank
101 venting conduit
102 regenerating conduit
103 filter
104 shut-off valve
105 shut-off safety valve
106 dosing valve
107 suction region
108 throttle member
109 air filter
110 combustion engine
111 supercharger
112 sensor
113 controller or regulator
A_{IC} cross-sectional area of the interrupter channel
A_{P} effective area of the paddle
A_{SG} area of the sealing gap
B blower
R rotational axis
Wₐ axial gap width
Wᵣ radial gap width
α angular extent
β angular extent
γ angular extent
ϕ inclination of the paddle

1. A delivery device for a medium to be delivered, for purging a filter for volatile fuel components, comprising a blower, which is embodied as a side channel blower or peripheral blower, and optionally an electric drive motor for the blower, the blower comprising:
1.1 a housing, comprising: an inlet and an outlet for the medium to be delivered; a delivery channel which extends in the circumferential direction and comprises a side channel; and an interrupter channel which extends in the circumferential direction for separating the inlet and the outlet; and
1.2 an impeller adapted to rotate in the housing about a rotational axis and comprises paddles which, when the impeller is rotated, pass through the delivery channel and the interrupter channel,
1.3 wherein the delivery device is configured such that the delivery-pressure-over-delivery-flow characteristic curve of the delivery device or the blower flattens or drops towards minimum delivery flow.

2. The delivery device according to claim 1, wherein the paddles and the interrupter channel form an axial sealing gap along the axially outer edge of the paddle on one or both end-facing sides of the respective paddle, exhibiting an axial gap width which is constant or increases only monotonically and progressing radially, and a radial sealing gap exhibiting a radial gap width along the radially outer edge of the respective paddle, over the angular extent of the interrupter channel, wherein the axial gap width and/or the radial gap width is/are of a size such that a specific leakage via the interrupter channel is established and the delivery-pressure-over-delivery-flow characteristic curve flattens or drops towards minimum delivery flow.

3. The delivery device according to claim 2, wherein the axial gap width and/or the radial gap width is/are constant along one of both end-facing sides and/or along the outer circumference of the respective paddle or increases only monotonically or decreases only monotonically along the respective sealing gap.

4. The delivery device according to claim 1, wherein the impeller and the interrupter channel limit an axial sealing gap over the angular extent of the interrupter channel, in order to seal off the interrupter channel towards the radially outer side, and said axial sealing gap widens axially at a base point of the paddle or on the radially outer side of the base point of the paddle on the axially outer edge of the respective paddle, such that an increased axial sealing gap between the respective paddle and the interrupter channel is obtained.

5. The delivery device according to claim 1, wherein:
the impeller comprises an outer circumference from which the paddles protrude radially outwards;
the paddles each comprise an outer edge which extends from an axially left-hand base point of the paddle on the outer circumference of the impeller up to an axially right-hand base point of the paddle on the outer circumference of the impeller via a radially outer circumference of the respective paddle;
the interrupter channel and the respective paddle form a sealing gap which extends around the outer edge of the paddle from the left-hand base point of the paddle up to the right-hand base point of the paddle;
the sealing gap exhibits an area, as projected into a longitudinal sectional plane of the impeller in the rotational direction of the impeller, wherein the rotational axis of the impeller extends in this longitudinal sectional plane;
the respective paddle exhibits an effective area, as projected into said longitudinal sectional plane in the rotational direction; and
a ratio between the area of the sealing gap and the effective area of the paddle measures at least 0.06 or at least 0.07 or at least 0.08.

6. The delivery device according to claim 1, wherein the paddles comprise a convex rounded profile or an oblique chamfer, which extends in the circumferential direction, on at least one axially outer edge of the paddle and/or on the radially outer edge of the paddle.

7. The delivery device according to claim 1, wherein several or all of the paddles comprise a radially outer edge which in a plan view onto a front side of the respective paddle is convexly or concavely arched radially inwards or radially outwards proceeding from both axial end-facing sides or is polygonal.

8. The delivery device according to claim 7, wherein the radially outer edge is roundly arched radially inwards in the plan view onto the front side of the respective paddle.

9. The delivery device according to claim 7, wherein the radially outer edge is polygonal, namely, trapezium-shaped in the plan view onto the front side of the respective paddle.

10. The delivery device according to claim 1, wherein several or all of the paddles comprise at least one paddle portion which points towards a rotational axis of the impeller in an axial view of the impeller at an inclination to a radial which extends through the respective paddle.

11. The delivery device according to claim 1, comprising the electric drive motor and a power limiter for limiting the electric power which can be supplied to the drive motor to a maximum electric power.

12. The delivery device according to claim 11, wherein the power limiter is a current limiter limiting the electric current to a maximum current.

13. The delivery device according to claim 1, comprising the electric drive motor and a controller or regulator for controlling or regulating the drive motor.

14. The delivery device according to claim 13, wherein the controller or regulator is configured to supply the drive motor with a constant electric voltage and control or regulate the strength of the electric current.

15. The delivery device according to the claim 13, comprising a dosing member which is connected to the blower and can be adjusted by the controller or regulator between a state of minimum throughput and a state of maximum throughput.

16. The delivery device according to claim 15, wherein the state of minimum throughput is a closed state.

17. The delivery device according to claim 15, wherein the dosing member is a dosing valve.

18. The delivery device according to claim 13, wherein the controller or regulator is configured to operate the blower in a lower rotational speed range of at most 5,000 rpm or at most 3,000 rpm when a predetermined threshold requirement of medium to be delivered is undercut, and to set the volume flow of the medium to be delivered by the dosing member.

19. The delivery device according to claim 13, wherein the controller or regulator is configured to operate the blower in an upper rotational speed range of at least 10,000 rpm or at least 15,000 rpm when a predetermined threshold requirement of medium to be delivered is exceeded, and to set the dosing member to a maximum throughput.

20. The delivery device according to claim 1, further comprising a bypass which connects a high-pressure side of the blower to a low-pressure side of the blower by bypassing the interrupter channel, wherein the high-pressure side extends from the delivery channel via the outlet up to a closing or dosing member which succeeds the blower downstream of the blower, and the low-pressure side extends via the inlet up to and into the delivery channel.

21. The delivery device according to claim 20, wherein the closing or dosing member is a dosing valve.

22. The delivery device according to claim 1, wherein the delivery device is used as a purge device for a combustion engine.

23. The delivery device according claim 22, wherein the combustion engine is a drive motor of a motor vehicle.
